(19) United States
(12) Patent Application Publication
(10) Pub. No.: US 2024/0032027 A1
(43) Pub. Date: Jan. 25, 2024

(54) ACKNOWLEDGMENT INDICATIONS FOR DOWNLINK CONTROL INFORMATION BASED TRANSMISSIONS

(71) Applicant: QUALCOMM INCORPORATED, San Diego, CA (US)

(72) Inventors: Fang YUAN, Beijing (CN); Yan ZHOU, San Diego, CA (US); Sony AKKARAKARAN, Poway, CA (US); Tao LUO, San Diego, CA (US); Juan MONTOJO, San Diego, CA (US); Peter GAAL, San Diego, CA (US)

(21) Appl. No.: 18/253,371

(22) PCT Filed: Jan. 9, 2021
(86) PCT No.: PCT/CN2021/070990

§ 371 Date: May 17, 2023

(51) Int. Cl. H04W 72/1268; H04W 72/232; H04L 5/00; H04W 72/11

(52) U.S. Cl. CPC H04W 72/1268; H04W 72/232; H04L 5/0051; H04W 72/11

(57) ABSTRACT

Methods, systems, and devices for wireless communications are described. A base station may transmit a downlink control information message to a user equipment (UE) that includes both a first indication of one or more transmission configuration indicator (TCI) states for the UE to use for communications with the base station and a second indication of one or more uplink transmissions to be sent by the UE. In some implementations, the UE may use one of the one or more indicated TCI states to communicate with the base station after a delay (or offset) from sending an uplink transmission of the one or more uplink transmissions. For example, the delay may include an amount of time or a quantity of symbols between transmitting the uplink transmission of the one or more uplink transmissions and communicating with the base station using the one of the one or more indicated TCI states.

### TECHNICAL FIELD

The present application is a 371 national stage filing of International PCT Application No. PCT/CN2021/070990 by YUAN et al. entitled “ACKNOWLEDGMENT INDICATIONS FOR DOWNLINK CONTROL INFORMATION BASED TRANSMISSIONS,” filed Jan. 9, 2021, which is assigned to the assignee hereof, and which is expressly incorporated by reference in its entirety herein.

### TECHNICAL FIELD

The following relates to wireless communications, including acknowledgment indications for downlink control information (DCI)-based transmissions.

### DESCRIPTION OF THE RELATED TECHNOLOGY

Wireless communications systems are widely deployed to provide various types of communication content such as voice, video, packet data, messaging, broadcast, and so on. These systems may be capable of supporting communication with multiple users by sharing the available system resources (for example, time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM).

A wireless multiple-access communications system may include one or more base stations or one or more network access nodes, each simultaneously supporting communication for multiple communication devices, which may be otherwise known as user equipment (UE). In some examples, a base station may explicitly or implicitly indicate a transmission configuration indicator (TCI) state for a UE to use for communications with the base station. For example, the TCI state may correspond to a beam for the UE to use for the communications with the base station (for example, for uplink communications or downlink communications or both). Techniques are desired for supporting communications between a UE and a base station using an indicated TCI state.

### SUMMARY

The described techniques relate to improved methods, systems, devices, and apparatuses that support acknowledgment indications for downlink control information (DCI)-based transmissions. Generally, the described techniques relate to a base station transmitting a DCI message to a user equipment (UE) that includes both a first indication of one or more transmission configuration indicator (TCI) states for the UE to use for communications with the base station and a second indication of one or more uplink transmissions to be sent by the UE. In some implementations, the UE may use one of the one or more indicated TCI states (for example, as indicated by the first indication) to communicate with the base station after a delay (for example, an offset) relative to sending an uplink transmission of the one or more uplink transmissions (for example, as indicated by the second indication). For example, the delay may include an amount of time or a quantity of symbols between transmitting the uplink transmission of the one or more uplink transmissions and communicating with the base station using the one of the one or more indicated TCI states. In some examples, the one or more uplink transmissions may include one or more uplink shared channel transmissions (for example, a physical uplink shared channel (PUSCH) transmission), one or more sounding reference signal (SRS) transmissions, one or more channel state information (CSI) reports, one or more acknowledgment feedback transmission for semi-persistent scheduling (SPS) downlink channels (for example, SPS physical downlink shared channel (PDSCH)), one or more confirmation message transmissions for a configured grant activation, one or more configured grant uplink transmissions (for example, a PUSCH transmission on resources indicated by a configured grant), or any combination thereof.

One innovative aspect of the subject matter described in this disclosure can be implemented in a method for wireless communications at a UE. The method may include receiving, from a base station, a DCI message including a first indication of one or more TCI states for communications with the base station and a second indication corresponding to one or more uplink transmissions for transmitting to the base station; transmitting, to the base station, at least one of the one or more uplink transmissions based on receiving the DCI including the second indication; and communicating with the base station using the one or more TCI states and after a delay, the delay initiated based on transmitting the at least one of the one or more uplink transmissions.

Another innovative aspect of the subject matter described in this disclosure can be implemented in an apparatus for wireless communications at a UE. The apparatus may include a processor, memory in electronic communication with the processor, and instructions stored in the memory. The instructions may be executable by the processor to cause the apparatus to receive, from a base station, a DCI message including a first indication of one or more TCI states for communications with the base station and a second indication corresponding to one or more uplink transmissions for transmitting to the base station; to transmit, to the base station, at least one of the one or more uplink transmissions based on receiving the DCI including the second indication; and to communicate with the base station using the one or more TCI states and after a delay, the delay initiated based on transmitting the at least one of the one or more uplink transmissions.

Another innovative aspect of the subject matter described in this disclosure can be implemented in another apparatus for wireless communications at a UE. The apparatus may include means for receiving, from a base station, a DCI message including a first indication of one or more TCI states for communications with the base station and a second indication corresponding to one or more uplink transmissions for transmitting to the base station; means for transmitting, to the base station, at least one of the one or more uplink transmissions based on receiving the DCI including the second indication; and means for communicating with the base station using the one or more TCI states and after a delay, the delay initiated based on transmitting the at least one of the one or more uplink transmissions

Another innovative aspect of the subject matter described in this disclosure can be implemented in a non-transitory computer-readable medium storing code for wireless communications at a UE. The code may include instructions executable by a processor to receive, from a base station, a DCI message including a first indication of one or more TCI states for communications with the base station and a second indication corresponding to one or more uplink transmissions for transmitting to the base station; to transmit, to the base station, at least one of the one or more uplink transmissions based on receiving the DCI including the second indication; and to communicate with the base station using the one or more TCI states and after a delay, the delay initiated based on transmitting the at least one of the one or more uplink transmissions

One innovative aspect of the subject matter described in this disclosure can be implemented in a method for wireless communications at a base station. The method may include transmitting, to a UE, a DCI message including a first indication of one or more TCI states for the UE to use for communications with the base station and a second indication corresponding to one or more uplink transmissions for the UE to transmit to the base station; receiving, from the UE, at least one of the one or more uplink transmissions based on transmitting the DCI including the second indication; and communicating with the UE using the one or more TCI states and after a delay, the delay initiated based on receiving the at least one of the one or more uplink transmissions

Another innovative aspect of the subject matter described in this disclosure can be implemented in an apparatus for wireless communications at a base station. The apparatus may include a processor, memory in electronic communication with the processor, and instructions stored in the memory. The instructions may be executable by the processor to cause the apparatus to transmit, to a UE, a DCI message including a first indication of one or more TCI states for the UE to use for communications with the base station and a second indication corresponding to one or more uplink transmissions for the UE to transmit to the base station; to receive, from the UE, at least one of the one or more uplink transmissions based on transmitting the DCI including the second indication; and to communicate with the UE using the one or more TCI states and after a delay, the delay initiated based on receiving the at least one of the one or more uplink transmissions

Another innovative aspect of the subject matter described in this disclosure can be implemented in another apparatus for wireless communications at a base station. The apparatus may include means for transmitting, to a UE, a DCI message including a first indication of one or more TCI states for the UE to use for communications with the base station and a second indication corresponding to one or more uplink transmissions for the UE to transmit to the base station; means for receiving, from the UE, at least one of the one or more uplink transmissions based on transmitting the DCI including the second indication; and means for communicating with the UE using the one or more TCI states and after a delay, the delay initiated based on receiving the at least one of the one or more uplink transmissions

Another innovative aspect of the subject matter described in this disclosure can be implemented in a non-transitory computer-readable medium storing code for wireless communications at a base station. The code may include instructions executable by a processor to transmit, to a UE, a DCI message including a first indication of one or more TCI states for the UE to use for communications with the base station and a second indication corresponding to one or more uplink transmissions for the UE to transmit to the base station; to receive, from the UE, at least one of the one or more uplink transmissions based on transmitting the DCI including the second indication; and to communicate with the UE using the one or more TCI states and after a delay, the delay initiated based on receiving the at least one of the one or more uplink transmissions.

### BRIEF DESCRIPTION OF THE DRAWINGS

FIG. 1 illustrates an example of a wireless communications system that supports acknowledgment indications for downlink control information (DCI)-based transmissions in accordance with aspects of the present disclosure.

FIG. 2 illustrates an example of a wireless communications system that supports acknowledgment indications for DCI-based transmissions in accordance with aspects of the present disclosure.

FIGS. 3-7 illustrate examples of timelines that support acknowledgment indications for DCI-based transmissions in accordance with aspects of the present disclosure.

FIG. 8 illustrates an example of a process flow that supports acknowledgment indications for DCI-based transmissions in accordance with aspects of the present disclosure.

FIGS. 9 and 10 show block diagrams of devices that support acknowledgment indications for DCI-based transmissions in accordance with aspects of the present disclosure.

FIG. 11 shows a block diagram of a communications manager that supports acknowledgment indications for DCI-based transmissions in accordance with aspects of the present disclosure.

FIG. 12 shows a diagram of a system including a device that supports acknowledgment indications for DCI-based transmissions in accordance with aspects of the present disclosure.

FIGS. 13 and 14 show block diagrams of devices that support acknowledgment indications for DCI-based transmissions in accordance with aspects of the present disclosure.

FIG. 15 shows a block diagram of a communications manager that supports acknowledgment indications for DCI-based transmissions in accordance with aspects of the present disclosure.

FIG. 16 shows a diagram of a system including a device that supports acknowledgment indications for DCI-based transmissions in accordance with aspects of the present disclosure.

FIGS. 17 and 18 show flowcharts illustrating methods that support acknowledgment indications for DCI-based transmissions in accordance with aspects of the present disclosure.

### DETAILED DESCRIPTION

In some wireless communications systems, devices may employ a unified transmission configuration indicator (TCI) framework to communicate with each other. In this unified TCI framework, a joint common TCI state may indicate a common beam for at least one downlink channel (or downlink reference signal transmission) and at least one uplink channel (or uplink reference signal transmission), a downlink common TCI state may indicate a common beam used for at least two downlink channels, or an uplink common TCI state may indicate a common beam used for at least two uplink channels. In some examples, a base station may indicate for a user equipment (UE) to use the unified TCI framework by, for example, transmitting a downlink control information (DCI) to the UE that contains an indicator for the unified TCI framework. In some cases, an acknowledgement message for a downlink channel scheduled by the DCI carrying the unified TCI framework indication can also be implemented as an acknowledgment for the DCI to indicate successful reception of the unified TCI framework indication, and the unified TCI framework may be applied for communications based on a delay after receiving the DCI or transmitting the acknowledgment message, among other examples.

However, tying the acknowledgment for the DCI to the acknowledgment for the scheduled downlink channel may cause potential drawbacks. For example, the UE may decode the DCI successfully, but may fail in decoding the scheduled downlink channel, or the UE may partially decode the scheduled downlink channel, or the base station may fail to decode uplink control information (UCI) (for example, carrying the acknowledgment feedback), or the UE may be scheduled with other uplink transmissions. In these different situations, the UE may transmit an acknowledgment message that does not accurately convey whether the DCI was successfully received or not.

Various aspects of the present disclosure generally relate to using a unified TCI framework for communications between two devices, and more specifically, to transmitting an implicit acknowledgment message to confirm whether an indication of the unified TCI framework was successfully received before using the unified TCI framework. Upon receiving an indication of a unified TCI framework (for example, a beam indication) in a DCI from a base station in which the DCI also corresponds to at least one uplink transmission, a UE may apply the unified TCI framework for communications with the base station after acknowledgment of the unified TCI framework (for example, plus a delay). In some examples, the acknowledgment of the unified TCI framework may include transmitting the at least one uplink transmission (for example, an implicit acknowledgment message). For example, the DCI, in addition to carrying the indication of the unified TCI framework, may schedule an uplink shared channel, one or more sounding reference signal (SRS) transmissions, one or more channel state information (CSI) reports, one or more semi-persistent scheduling (SPS) downlink channel reception opportunities with associated ACK feedback messages for the SPS downlink channel reception opportunities, or one or more uplink configured grant transmissions, and the UE may begin counting down the delay upon transmitting one of these different types of uplink transmissions. In some implementations, the delay may begin at one symbol (for example, a first or last symbol) of a transmission, such as an actual uplink transmission or a nominal uplink transmission (for example, a nominal uplink transmission may include an opportunity for a transmission of the uplink transmission, but the uplink transmission may not actually be transmitted).

Particular aspects of the subject matter described in this disclosure may be implemented to realize one or more of the following potential advantages. The techniques employed by the described communication devices may provide benefits and enhancements to the operation of the communication devices, including increased reliability for using a common beam for communications between the communication devices. For example, operations performed by the described communication devices may provide improvements to acknowledging a joint downlink/uplink beam indication or a separate downlink/uplink beam indication (for example, for a unified TCI framework), in which the joint downlink/uplink beam or separate downlink/uplink beam can be used after a delay from acknowledging the corresponding indication. In some implementations, the operations performed by the described communication devices to acknowledge the indication may include transmitting an uplink transmission indicated by a same control message (for example, a DCI message) that may include the joint downlink/uplink beam indication or the separate downlink/uplink beam indication. By implicitly acknowledging the indication by transmitting an uplink message, the communication devices may more efficiently acknowledge the indication as opposed to transmitting an explicit acknowledgment message for the control message that carries the joint downlink/uplink beam indication or the separate downlink/uplink beam indication which may or may not accurately capture whether the corresponding beam indication was successfully received or not. This implicit acknowledgment may decrease latency and improve communication reliability, among various other benefits.

Aspects of the disclosure are initially described in the context of wireless communications systems. Additionally, aspects of the disclosure are illustrated through an additional wireless communications system, different timeline examples, and a process flow. Aspects of the disclosure are further illustrated by and described with reference to apparatus diagrams, system diagrams, and flowcharts that relate to acknowledgment indications for DCI-based transmissions.

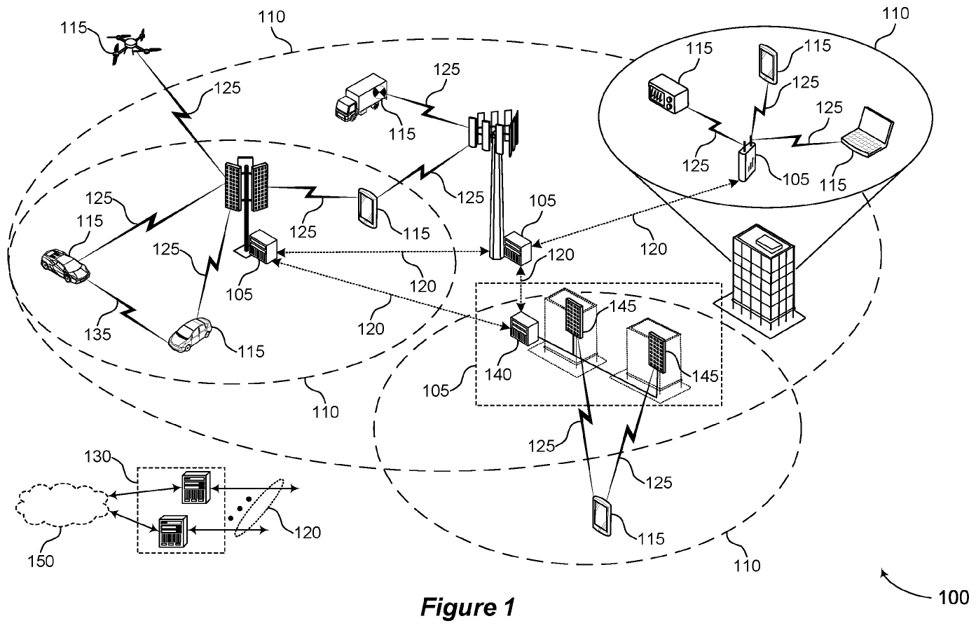

FIG. 1 illustrates an example of a wireless communications system 100 that supports acknowledgment indications for DCI-based transmissions in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (for example, mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (for example, core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (for example, via an S1, N2, N3, or other interface). The base stations 105 may communicate with one another over the backhaul links 120 (for example, via an X2, Xn, or other interface) either directly (for example, directly between base stations 105), or indirectly (for example, via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, in which the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (for example, a bandwidth part (BWP)) that is operated according to one or more physical layer channels for a given radio access technology (for example, LTE, LTE-A, LTE-A Pro, NR). Each physical layer channel may carry acquisition signaling (for example, synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (for example, in a carrier aggregation configuration), a carrier may also have acquisition signaling or control signaling that coordinates operations for other carriers. A carrier may be associated with a frequency channel (for example, an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode in which initial acquisition and connection may be conducted by the UEs 115 via the carrier, or the carrier may be operated in a non-standalone mode in which a connection is anchored using a different carrier (for example, of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (for example, in an FDD mode) or may be configured to carry downlink and uplink communications (for example, in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (for example, 1.4, 3, 5, 10, 15, 20, 40, or 80 megahertz (MHz)). Devices of the wireless communications system 100 (for example, the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (for example, a sub-band, a BWP) or all of a carrier bandwidth.

Signal waveforms transmitted over a carrier may be made up of multiple subcarriers (for example, using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (for example, a duration of one modulation symbol) and one subcarrier, in which the symbol period and subcarrier spacing are inversely related. The number of bits carried by each resource element may depend on the modulation scheme (for example, the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (for example, spatial layers or beams), and the use of multiple spatial layers may further increase the data rate or data integrity for communications with a UE 115.

One or more numerologies for a carrier may be supported, in which a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, in which Δfₘₐₓ may represent the maximum supported subcarrier spacing, and N_{f} may represent the maximum supported discrete Fourier transform (DFT) size. Time intervals of a communications resource may be organized according to radio frames each having a specified duration (for example, 10 milliseconds (ms)). Each radio frame may be identified by a system frame number (SFN) (for example, ranging from 0 to 1023).

Each frame may include multiple consecutively numbered subframes or slots, and each subframe or slot may have the same duration. In some examples, a frame may be divided (for example, in the time domain) into subframes, and each subframe may be further divided into a number of slots. Alternatively, each frame may include a variable number of slots, and the number of slots may depend on subcarrier spacing. Each slot may include a number of symbol periods (for example, depending on the length of the cyclic prefix prepended to each symbol period). In some wireless communications systems 100, a slot may further be divided into multiple mini-slots containing one or more symbols. Excluding the cyclic prefix, each symbol period may contain one or more (for example, N_{f}) sampling periods. The duration of a symbol period may depend on the subcarrier spacing or frequency band of operation.

A subframe, a slot, a mini-slot, or a symbol may be the smallest scheduling unit (for example, in the time domain) of the wireless communications system 100 and may be referred to as a transmission time interval (TTI). In some examples, the TTI duration (for example, the number of symbol periods in a TTI) may be variable. Additionally or alternatively, the smallest scheduling unit of the wireless communications system 100 may be dynamically selected (for example, in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (for example, a control resource set (CORESET)) for a physical control channel may be defined by a number of symbol periods and may extend across the system bandwidth or a subset of the system bandwidth of the carrier. One or more control regions (for example, CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (for example, control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (for example, over a carrier) and may be associated with an identifier for distinguishing neighboring cells (for example, a physical cell identifier (PCID), a virtual cell identifier (VCID), or others). In some examples, a cell may also refer to a geographic coverage area 110 or a portion of a geographic coverage area 110 (for example, a sector) over which the logical communication entity operates. Such cells may range from smaller areas (for example, a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (for example, several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (for example, licensed, unlicensed) frequency bands as macro cells. Small cells may provide unrestricted access to the UEs 115 with service subscriptions with the network provider or may provide restricted access to the UEs 115 having an association with the small cell (for example, the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (for example, MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (for example, via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (for example, a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode if not engaging in active communications, operating over a limited bandwidth (for example, according to narrowband communications), or a combination of these techniques. For example, some UEs 115 may be configured for operation using a narrowband protocol type that is associated with a defined portion or range (for example, set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (for example, mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (for example, using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (for example, UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (for example, base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (for example, a mobility management entity (MME), an access and mobility management function (AMF)) and at least one user plane entity that routes packets or interconnects to external networks (for example, a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (for example, radio heads and ANCs) or consolidated into a single network device (for example, a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (for example, less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (for example, from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. If operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (for example, LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (for example, the same codeword) or different data streams (for example, different codewords). Different spatial layers may be associated with different antenna ports used for channel measurement and reporting. MIMO techniques include single-user MIMO (SU-MIMO), in which multiple spatial layers are transmitted to the same receiving device, and multiple-user MIMO (MU-MIMO), in which multiple spatial layers are transmitted to multiple devices.

Beamforming, which may also be referred to as spatial filtering, directional transmission, or directional reception, is a signal processing technique that may be used at a transmitting device or a receiving device (for example, a base station 105, a UE 115) to shape or steer an antenna beam (for example, a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (for example, with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (for example, antenna panels) to conduct beamforming operations for directional communications with a UE 115. Some signals (for example, synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (for example, by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (for example, a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (for example, by a base station 105 or a UE 115) may be performed using multiple beam directions, and the device may use a combination of digital precoding or radio frequency beamforming to generate a combined beam for transmission (for example, from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (for example, a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (for example, a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (for example, for identifying a beam direction for subsequent transmission or reception by the UE 115) or for transmitting a signal in a single direction (for example, for transmitting data to a receiving device).

A receiving device (for example, a UE 115) may try multiple receive configurations (for example, directional listening) if receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (for example, different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (for example, if receiving a data signal). The single receive configuration may be aligned in a beam direction determined based on listening according to different receive configuration directions (for example, a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (for example, using a cyclic redundancy check (CRC)), forward error correction (FEC), and retransmission (for example, automatic repeat request (ARQ)). HARQ may improve throughput at the MAC layer in poor radio conditions (for example, low signal-to-noise conditions). In some examples, a device may support same-slot HARQ feedback, in which the device may provide HARQ feedback in a specific slot for data received in a previous symbol in the slot. In other cases, the device may provide HARQ feedback in a subsequent slot, or according to some other time interval.

In some wireless communications systems, two devices may use different TCI states for communications between each other. In some examples, the two devices may use a unified TCI framework for the communications. The unified TCI framework may include a joint common TCI state for uplink and downlink communications, a separate uplink common TCI state, a separate downlink common TCI state, or any combination thereof. For example, the joint common TCI state for uplink and downlink communications may indicate a common beam for at least one downlink channel (or downlink reference signal) and at least one uplink channel (or uplink reference signal), the separate downlink common TCI state may indicate a common beam for at least two downlink channels (or downlink reference signals), and the separate uplink common TCI state may indicate a common beam for at least two uplink channels (or uplink reference signals). For the unified TCI framework, a UE 115 may support a joint TCI for downlink and uplink communications based on a downlink TCI framework. In some implementations, the term “TCI” may include a TCI state that includes at least one source reference signal to provide a reference (for example, for UE assumption) for a device to determine a quasi-colocation (QCL), a spatial filter, or both for communications with an additional device.

On the unified TCI framework, to accommodate the case of separate beam indications for uplink and downlink communications, a UE 115 may utilize two separate TCI states (for example, one TCI state for the downlink communications and one TCI state for the uplink communications). For the separate downlink common TCI state, one or more source reference signals in M TCIs may provide QCL information at least for UE-dedicated reception on a downlink shared channel (for example, a physical downlink shared channel (PDSCH)) and for UE-dedicated reception on all or a subset of CORESETs in a component carrier. For the separate uplink common TCI state, one or more source reference signals in N TCIs may provide a reference for determining a common uplink transmission spatial filter at least for a dynamic-grant or configured-grant based uplink shared channel (for example, a physical uplink shared channel (PUSCH)) or for all or a subset of dedicated uplink control channel resources (for example, physical uplink control channel (PUCCH) resources) in a component carrier. In some cases, this uplink transmission spatial filter may also apply to all SRS resources in one or more resource sets configured for antenna switching, codebook-based uplink transmissions, non-codebook-based uplink transmissions, or any combination thereof.

For the unified TCI framework (for example, common beam TCI state), a UE 115 may be indicated either explicitly or implicitly at least one set of multiple applicable channels (or reference signals) to which each type of TCI state can be applied. Additionally, TCI states may include the following types. A first type may include the joint common TCI state for uplink and downlink communications (for example, a joint DL/UL common TCI state) as described previously (for example, to indicate a common beam for at least one downlink channel or downlink reference signal plus at least one uplink channel or uplink reference signal). A second type may include the separate downlink common TCI state as described previously (for example, to indicate a common beam for at least two downlink channels or downlink reference signals). A third type may include the separate uplink common TCI state as described previously (for example, to indicate a common beam for at least two uplink channels or uplink reference signals). A fourth type may include a separate downlink single channel or downlink reference signal TCI state to indicate a beam for a single downlink channel or downlink reference signal. A fifth type may include a separate uplink single channel or uplink reference signal RS TCI state to indicate a beam for a single uplink channel or uplink reference signal.

In some cases, an association may exist between one or more channels, one or more source reference signals, or both and a common beam TCI (for example, a unified TCI framework). The one or more channels and one or more reference signals applicable of each TCI type may include the following candidates: UE specific or non-UE specific physical downlink control channel (PDCCH), PDSCH, PUCCH, PUSCH; synchronization signal/physical broadcast channel block (SSB), periodic CSI reference signal (CSI-RS), semi-periodic CSI-RS, aperiodic CSI-RS, periodic positioning reference signal (PRS), semi-periodic PRS, aperiodic PRS; periodic SRS, semi-periodic SRS, aperiodic SRS; or any combination thereof.

The PDSCH, PUCCH, and PUSCH may be dynamically scheduled (for example, by DCI), semi-statically activated (for example, by DCI or a MAC control element (CE)), or semi-statically configured (for example, by RRC). The PDSCH may enable a scheduling offset between a DCI and the PDSCH that is equal to or greater than a beam switch latency threshold or a scheduling offset that is less than the beam switch latency threshold. Additionally, the PDCCH may be carried by all or a subset of CORESETs. The purpose of the CSI-RSs may be for CSI measurements and a CSI report (if higher layer parameters are not indicated, such as tracking reference signal (TRS) information or a repetition parameter), for a beam measurement and report (if a higher layer parameter for repetition is included), for TRS measurement (if a higher layer parameter for TRS information is included), or for any combination thereof. The purpose of the SRS may be for antenna switching, beam management, codebook based PUSCH, and non-codebook based PUSCH. In some cases, the PUCCH, SSB, CSI-RS, PRS, SRS, or any combination thereof may be all or a subset of corresponding configured resources.

In some cases, a base station 105 may use a DCI-based beam indication framework to indicate one or more TCI states for a UE 115 to use. For example, on beam indication signaling medium to support joint or separate downlink or uplink beam indications for the unified TCI framework, the base station 105 and the UE 115 may support a Layer 1 (L1)-based beam indication using at least UE-specific (that is, unicast) DCI to indicate joint or separate downlink or uplink beam indications from active TCI states for the UE 115. In some examples, DCI formats 1_1 and 1_2 may be used for this beam indication. Additionally, the UE 115 may support a mechanism to acknowledge successful decoding of beam indication. For example, an acknowledgment feedback (for example, a positive acknowledgment (ACK) or a confirmation; or a negative acknowledgment (NACK)) of a PDSCH scheduled by the DCI carrying the beam indication may be used as an acknowledgment feedback also for the DCI.

Additionally or alternatively, a base station 105 and a UE 115 may support a DCI-based carrier aggregation beam indication. For example, for the unified TCI framework, the base station 105 and the UE 115 may support a common TCI state identifier (ID) update and activation to provide common QCL information, one or more common uplink transmissions spatial filters across a set of configured component carriers, or both. This common TCI state ID update and activation may apply to intra-band carrier aggregation, to a joint downlink/uplink beam indication, to separate downlink and uplink beam indications, or any combination thereof. Additionally, the common TCI state ID may indicate that a same or single reference signal determined according to the TCI states indicated by a common TCI state ID may be used to provide a QCL indication (for example, a QCL Type-D indication) and to determine an uplink transmission spatial filter across a set of configured component carriers.

In some cases, a base station 105 and a UE 115 may use a timeline for a DCI-based beam indication framework to determine when to start using the beam framework (for example, TCI states or beams) indicated by the DCI. For example, if a beam indication is received in a DCI, the UE 115 may begin using one or more beams indicated by the beam indication in a first slot (or different length TTI) that is at least X ms or Y symbols after the DCI with the beam indication is received (for example, a joint downlink/uplink beam indication or separate downlink/uplink beam indications). Alternatively, if a beam indication is received in a DCI, the UE 115 may begin using one or more beams indicated by the beam indication in a first slot that is at least X ms or Y symbols after an acknowledgment of the joint or separate downlink/uplink beam indication is transmitted by the UE 115. Existing timing defined for DCI-based TCI or spatial relation updates may be used for X and Y, or new timing may be defined for X and Y. Additionally, the UE 115 and the base station 105 may apply this delay (for example, a minimum indication delay) in some situations but not in other situations. For example, the UE 115 and the base station 105 may use the delay if a newly indicated beam is different than a previously indicated beam.

However, for the alternative in which the UE 115 begins using one or more beams indicated by the beam indication in a first slot that is at least X ms or Y symbols after an acknowledgment of the joint or separate downlink/uplink beam indication is transmitted by the UE 115, the acknowledgment of the joint or separate downlink/uplink beam indication may not be clear due to the following issues. In some examples, the UE 115 may decode the DCI successfully but decoding the PDSCH may fail, such that a NACK bit transmitted for the PDSCH does not mean that the UE 115 has failed to decode the DCI. Additionally or alternatively, the UE 115 may decode some part of the PDSCH while losing one or more other parts of the PDSCH (for example, if the PDSCH has multiple transport blocks (TBs) or codeblock groups (CBGs)). In other examples, the UE 115 may transmit an ACK for the PDSCH, but the base station 105 may fail to decode UCI carrying the ACK (for example, a PUCCH failure or a last DCI mis-detection). Additionally or alternatively, the UE 115 may be scheduled with other uplink transmissions (for example, SRSs or PUSCHs). In these different situations, the UE 115 may transmit an acknowledgment message that does not accurately convey whether the DCI carrying the beam indication is successfully received or not.

The wireless communications system 100 may support techniques for a UE 115 to implicitly acknowledge that a beam indication (or indication of one or more TCI states) was received (for example, in a DCI message) and then may use one or more beams indicated by the beam indication after a delay that is initiated upon the implicit acknowledgment. For example, a base station 105 may transmit a DCI message to the UE 115 that includes a first indication of one or more TCI states for the UE 115 to use for communications with the base station 105. In some implementations, if the DCI message also includes a second indication corresponding to one or more uplink transmissions to be sent by the UE 115, the implicit acknowledgment may include the UE 115 transmitting at least one of the one or more uplink transmissions, and the UE 115 may begin using one of the one or more TCI states for communicating with the base station 105 after a delay based on transmitting the at least one of the one or more uplink transmissions. In some examples, the one or more uplink transmissions may include a PUSCH transmission, an SRS transmissions, CSI reports, acknowledgment feedback transmission for SPS downlink channels (for example, SPS PDSCHs), a confirmation message transmission for a configured grant activation, a configured grant uplink transmission (for example, a PUSCH transmission on resources indicated by a configured grant), or any combination thereof.

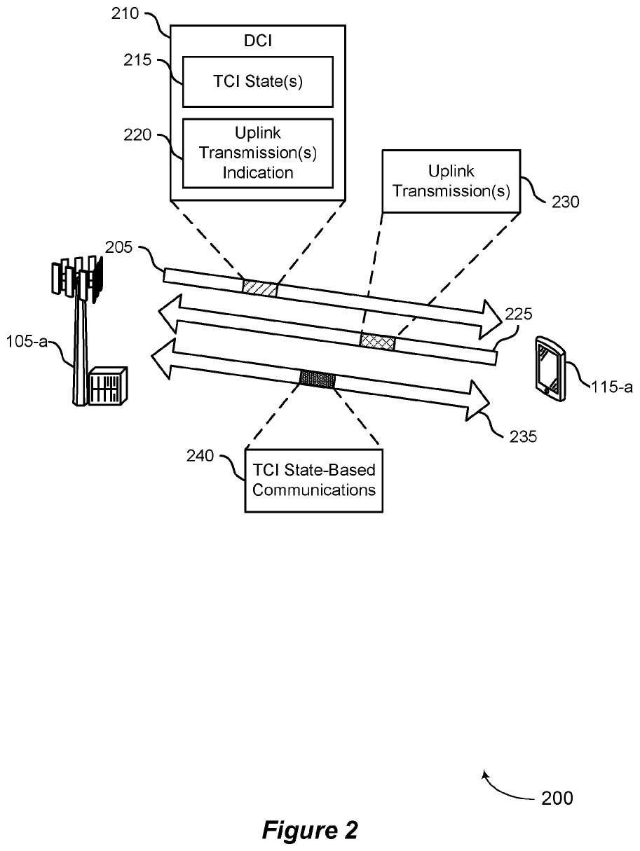

FIG. 2 illustrates an example of a wireless communications system 200 that supports acknowledgment indications for DCI-based transmissions in accordance with aspects of the present disclosure. The wireless communications system 200 may implement aspects of or may be implemented by aspects of the wireless communications system 200. For example, the wireless communications system 200 may include a base station 105-a and a UE 115-a, which may represent examples of base stations 105 and UEs 115, respectively, as described with reference to FIG. 1. Additionally, the base station 105-a and the UE 115-a may communicate on resources of a carrier 205 (for example, for downlink communications), a carrier 225 (for example, for uplink communications), and a carrier 235 (for example, for both downlink and uplink communications). Although shown as separate carriers, the carrier 205, the carrier 225, and the carrier 235 may include same or different resources (for example, time and frequency resources) for the corresponding transmissions. Additionally, the base station 105-a and the UE 115-a may support beamformed transmissions (for example, beams used for the beamformed transmissions may correspond to different TCI states).

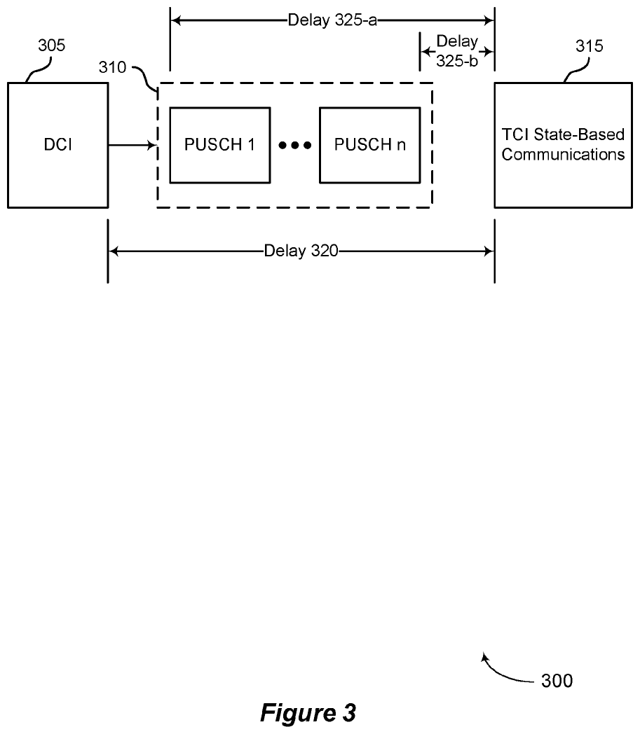

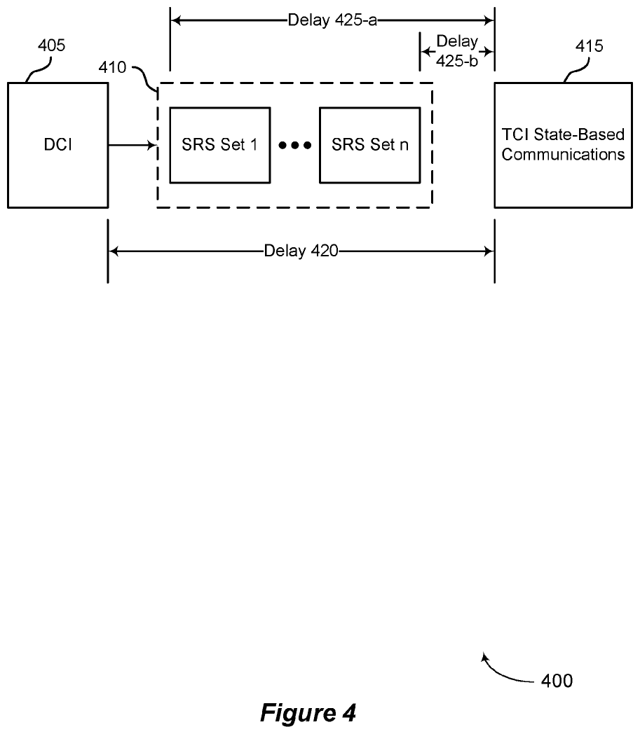

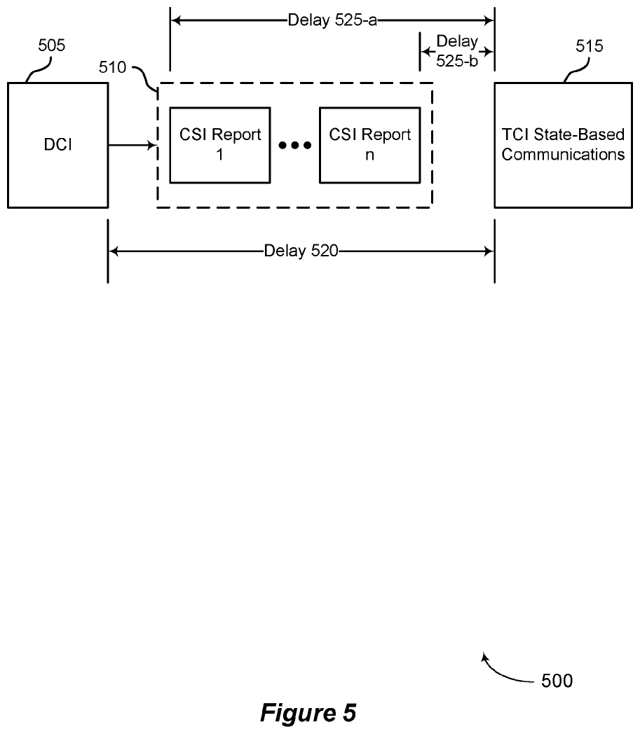

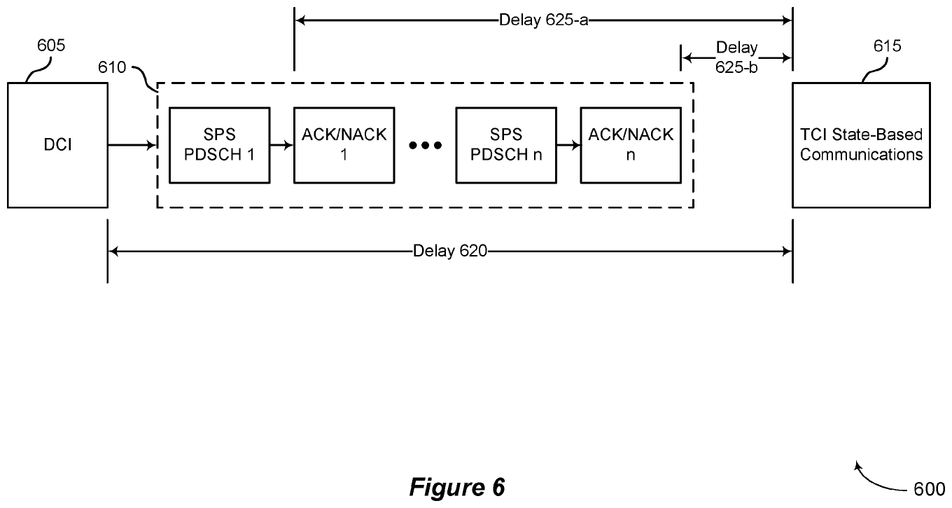

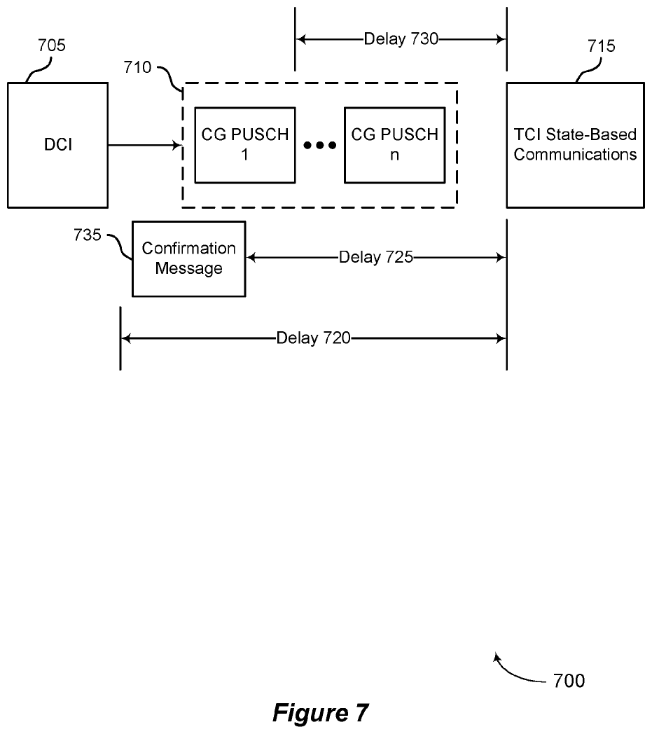

The wireless communications system 200 may support an implicit acknowledgement for a unified TCI indication (or unified TCI framework indication) as discussed with reference to FIG. 1. For example, for a beam indication (for example, an L1-based beam indication) using at least a UE-specific (for example, unicast) DCI to indicate joint or separate downlink/uplink beam indication (that is, the unified TCI indication or unified TCI framework indication) from active TCI states for the UE 115-a, the UE 115-a may apply the beam indication after an acknowledgment of the joint or separate downlink/uplink beam indication, in which the acknowledgment of the joint or separate downlink/uplink beam indication can be different variations. For example, the acknowledgment may include transmitting a PUSCH indicated in the same DCI as the beam indication (described in greater detail with reference to FIG. 3), transmitting an SRS indicated in the same DCI as the beam indication (described in greater detail with reference to FIG. 4), transmitting a CSI report indicated in the same DCI as the beam indication (described in greater detail with reference to FIG. 5), transmitting ACK/NACK feedback for an SPS PDSCH repetition indicated in the same DCI as the beam indication (described in greater detail with reference to FIG. 6), transmitting a configured grant activation confirmation message or a configured grant PUSCH transmission indicated in the same DCI as the beam indication (described in greater detail with reference to FIG. 7), or any combination thereof.

As shown in the example of FIG. 2, the base station 105-a may transmit a DCI 210 (for example, on resources of the carrier 205) that includes both an indication of one or more TCI states 215 (for example, beam indication, unified TCI framework indication, joint downlink/uplink beam indication, separate downlink/uplink beam indication) for the UE 115-a to use for communicating with the base station 105-a and an uplink transmission indication 220. For example, the DCI 210 may both indicate which TCI states 215 for the UE 115-a to use and may correspond to one or more uplink transmissions for the UE 115-a to transmit. That is, the uplink transmission indication 220 may indicate or may correspond to one or more uplink transmissions for the UE 115-a to transmit. For example, the uplink transmission indication 220 may indicate or may correspond to one or more PUSCH transmissions, one or more SRS transmissions, one or more CSI reports, ACK/NACK feedback for one or more SPS PDSCH repetitions, a confirmation message transmission for a configured grant activation indication, a configured grant PUSCH transmissions, or any combination thereof.

Before using the one or more TCI states 215, the UE 115-a may apply a delay (for example, a minimum indication delay) between transmitting an acknowledgment message for the indication of the one or more TCI states 215 and communicating with the base station 105-a using the one or more TCI states 215. However, rather than transmitting explicit acknowledgment message for the indication of the one or more TCI states 215 (which may increase signaling overhead) or transmitting an acknowledgment message for a downlink channel indicated by the DCI (which includes issues as described with reference to FIG. 1), the UE 115-a and the base station 105-a may use transmission of an uplink transmission corresponding to the uplink transmission indication 220 as an implicit acknowledgment for reception of the one or more TCI states 215. Subsequently, the one or more TCI states 215 may be used for communications, for example, after a delay that is initiated upon transmission of the uplink transmission.

For example, after receiving the DCI 210, the UE 115-a may transmit one or more uplink transmissions 230 (for example, on resources of the carrier 225) indicated by the DCI 210. Subsequently, the base station 105-a and the UE 115-a may then have TCI-state based communications 240 (for example, on resources of carrier 235) based on applying a delay after the one or more uplink transmissions 230 are sent by the UE 115-a. In some implementations, rather than including the uplink transmission indication 220, the DCI 210 may indicate a dormancy for a secondary cell (SCell) along with the indication of the one or more TCI states 215. If there are no PDSCH receptions on the SCell, however, the UE 115-a may ignore the indication of the one or more TCI states 215 (for example, beam indication) in the DCI 210.

FIG. 3 illustrates an example of a timeline 300 that supports acknowledgment indications for DCI-based transmissions in accordance with aspects of the present disclosure. The timeline 300 may implement aspects of or may be implemented by aspects of the wireless communications systems 100 and 200. For example, a UE 115 and a base station 105 may use the timeline 300 to determine when the UE 115 is to start using one or more TCI states (for example, beams) indicated by the base station 105 for communications with the base station 105. In some examples, the one or more TCI states may correspond to a unified TCI framework that indicates a common beam that can be used by the UE 115 for at least one uplink channel (or uplink reference signal) and for at least one downlink channel (or downlink reference signal), a common beam that can be used by the UE 115 for at least two downlink channels (or downlink reference signals), or a common beam that can be used by the UE 115 for at least two uplink channels (or uplink reference signals). The UE 115 may begin using the one or more TCI states after a delay that begins after receiving an indication of the one or more TCI states or transmitting an uplink transmission corresponding to the same indication that carries the one or more TCI states.

In the example of FIG. 3, the base station 105 may transmit a DCI 305 to the UE 115, and the DCI 305 may include a first indication of the one or more TCI states for the UE 115 to use for communications with the base station 105 and a second indication of one or more PUSCHs 310 scheduled for the UE 115 to transmit. In some implementations, the UE 115 may begin TCI state-based communications 315 with the base station 105 (for example, using at least one TCI state of the one or more indicated TCI states) after a delay 320 in a first slot (or different length TTI) that is at least X ms or Y symbols after the DCI 305 with the first indication of the one or more TCI states is received.

Additionally or alternatively, the UE 115 and the base station 105 may use transmission of one of the one or more PUSCHs 310 as an implicit acknowledgment for the first indication of the one or more TCI states and may initiate a delay 325 upon transmission of the one of the one or more PUSCHs 310. That is, a PUSCH transmission may be used as an acknowledgment indication of the one or more TCI states if the DCI 305 carrying the first indication of the one or more TCI states also schedules the one or more PUSCHs 310. Subsequently, the UE 115 may apply an indicated TCI state for the TCI state-based communications 315 in a first slot that is at least X ms or Y symbols from one (for example, a first or last) symbol of the scheduled PUSCH or from one (for example, a first or last) symbol of one (for example, an actual or a nominal) transmission of multiple scheduled PUSCH repetitions by the DCI 305. For example, the UE 115 may use a delay 325-a that begins from a first symbol of a first PUSCH scheduled by the DCI 305 before applying the indicated TCI state for the TCI state-based communications 315. Alternatively, the UE 115 may use a delay 325-b that begins from a last symbol of a last PUSCH scheduled by the DCI 305 before applying the indicated TCI state for the TCI state-based communications 315.

Although the delay 325-a and the delay 325-b are shown in the example of FIG. 3, different delays beginning from first or last symbols of other PUSCHs scheduled by the DCI 305 may be used. In some examples, a nominal transmission may include an opportunity for an uplink transmission, but the uplink transmission may be not actually sent. Additionally, the UE 115 may expect that a PUSCH scheduled by the DCI 305 containing the indication of the one or more TCI states (for example, joint or separate downlink/uplink beam indication) is differentiated from a configured grant PUSCH by any of a modulation and coding scheme (MCS), a scrambling sequence for demodulation reference signals (DMRSs), and a frequency domain resource allocation (FDRA).

FIG. 4 illustrates an example of a timeline 400 that supports acknowledgment indications for DCI-based transmissions in accordance with aspects of the present disclosure. The timeline 400 may implement aspects of or may be implemented by aspects of the wireless communications systems 100 and 200. For example, a UE 115 and a base station 105 may use the timeline 400 to determine when the UE 115 is to start using one or more TCI states (for example, beams) indicated by the base station 105 for communications with the base station 105. The UE 115 may begin using the one or more TCI states after a delay that begins after receiving an indication of the one or more TCI states or transmitting an uplink transmission corresponding to the same indication that carries the one or more TCI states.

In the example of FIG. 4, the base station 105 may transmit a DCI 405 to the UE 115, and the DCI 405 may include a first indication of the one or more TCI states for the UE 115 to use for communications with the base station 105 and a second indication of one or more SRS sets 410 scheduled for the UE 115 to transmit. In some implementations, the UE 115 may begin TCI state-based communications 415 with the base station 105 (for example, using at least one TCI state of the one or more indicated TCI states) after a delay 420 in a first slot (or different length TTI) that is at least X ms or Y symbols after the DCI 405 with the first indication of the one or more TCI states is received.

Additionally or alternatively, the UE 115 and the base station 105 may use transmission of one of the one or more SRS sets 410 as an implicit acknowledgment for the first indication of the one or more TCI states and may initiate a delay 425 upon transmission of the one of the one or more SRS sets 410. That is, an SRS transmission may be used as an acknowledgment indication of the one or more TCI states if the DCI 405 carrying the first indication of the one or more TCI states also schedules the one or more SRS sets 410. Subsequently, the UE 115 may apply an indicated TCI state for the TCI state-based communications 415 in a first slot that is at least X ms or Y symbols from one (for example, a first or last) symbol of a scheduled SRS transmission, from one (for example, a first or last) symbol of one (for example, an actual or a nominal) transmission of multiple scheduled SRS repetitions by the DCI 405, from transmission of one (for example, a lowest or highest) SRS resource set ID if multiple SRS resource sets are triggered by the DCI 405, or any combination thereof.

For example, the UE 115 may use a delay 425-a that begins from a first symbol of a first SRS set scheduled by the DCI 405 before applying the indicated TCI state for the TCI state-based communications 415. Alternatively, the UE 115 may use a delay 425-b that begins from a last symbol of a last SRS set scheduled by the DCI 405 before applying the indicated TCI state for the TCI state-based communications 415. Although the delay 425-a and the delay 425-b are shown in the example of FIG. 4, various different delays may be used, such as different delays beginning from first or last symbols of other SRS set transmissions scheduled by the DCI 405 may be used.

FIG. 5 illustrates an example of a timeline 500 that supports acknowledgment indications for DCI-based transmissions in accordance with aspects of the present disclosure. The timeline 500 may implement aspects of or may be implemented by aspects of the wireless communications systems 100 and 200. For example, a UE 115 and a base station 105 may use the timeline 500 to determine when the UE 115 is to start using one or more TCI states (for example, beams) indicated by the base station 105 for communications with the base station 105. The UE 115 may begin using the one or more TCI states after a delay that begins after receiving an indication of the one or more TCI states or transmitting an uplink transmission corresponding to the same indication that carries the one or more TCI states.

In the example of FIG. 5, the base station 105 may transmit a DCI 505 to the UE 115, and the DCI 505 may include a first indication of the one or more TCI states for the UE 115 to use for communications with the base station 105 and a second indication of one or more CSI reports 510 scheduled to be transmitted by the UE 115 (for example, a CSI request for semi-periodic CSI reports on a PUSCH, aperiodic CSI reports on a PUSCH, or aperiodic CSI reports on a PUCCH). In some implementations, the UE 115 may begin TCI state-based communications 515 with the base station 105 (for example, using at least one TCI state of the one or more indicated TCI states) after a delay 520 in a first slot (or different length TTI) that is at least X ms or Y symbols after the DCI 505 with the first indication of the one or more TCI states is received.

Additionally or alternatively, the UE 115 and the base station 105 may use transmission of one of the one or more CSI reports 510 as an implicit acknowledgment for the first indication of the one or more TCI states and may initiate a delay 525 upon transmission of the one of the one or more CSI reports 510. That is, a CSI report transmission may be used as an acknowledgment indication of the one or more TCI states if the DCI 505 carrying the first indication of the one or more TCI states also schedules the one or more CSI reports 510. Subsequently, the UE 115 may apply an indicated TCI state for the TCI state-based communications 415 in a first slot that is at least X ms or Y symbols from one (for example, a first or last) symbol of a scheduled CSI report transmission or from one (for example, a first or last) symbol of one (for example, an actual or a nominal) transmission of multiple scheduled CSI report transmissions by the DCI 505 (for example, CSI report with repetitions on different beams or for different TRPs). For example, the UE 115 may use a delay 525-a that begins from a first symbol of a first CSI report scheduled by the DCI 505 before applying the indicated TCI state for the TCI state-based communications 515. Alternatively, the UE 115 may use a delay 525-b that begins from a last symbol of a last CSI report scheduled by the DCI 505 before applying the indicated TCI state for the TCI state-based communications 515.

Although the delay 525-a and the delay 525-b are shown in the example of FIG. 5, different delays beginning from first or last symbols of other CSI reports scheduled by the DCI 505 may be used. Additionally or alternatively, if no CSI report is needed for uplink transmission, the UE 115 may ignore the first indication of the one or more TCI states in the DCI 505. For example, if the DCI 505 indicates for the UE 115 to perform a beam refinement procedure (for example, a P3 L1 beam operation) or a measurement operation using CSI and no CSI report is needed to be transmitted, the UE 115 may refrain from the TCI state-based communications 515 (the UE 115 may continue to communicate with the base station 105 but may not use the one or more indicated TCI states for the communications). In some examples, upon detection of the DCI 505 as having a specific DCI format (for example, a DCI format 0_1) with a non-zero input for one of the DCI fields (for example, a “CSI request” in the DCI field has a non-zero value) and an RRC configuration indicates that no CSI reports are triggered by an input in the DCI 505 (for example, an associated “reportQuantity” value in an CSI-ReportConfig is set to “none” for alone or more CSI reports triggered by “CSI request” in the DCI 505), the UE 115 may ignore the one or more indicated TCI states in the DCI 505 (for example, the UE 115 may refrain from the TCI state-based communications 515).

FIG. 6 illustrates an example of a timeline 600 that supports acknowledgment indications for DCI-based transmissions in accordance with aspects of the present disclosure. The timeline 600 may implement aspects of or may be implemented by aspects of the wireless communications systems 100 and 200. For example, a UE 115 and a base station 105 may use the timeline 600 to determine when the UE 115 is to start using one or more TCI states (for example, beams) indicated by the base station 105 for communications with the base station 105. The UE 115 may begin using the one or more TCI states after a delay that begins after receiving an indication of the one or more TCI states or transmitting an uplink transmission corresponding to the same indication that carries the one or more TCI states.

In the example of FIG. 4, the base station 105 may transmit a DCI 605 to the UE 115, and the DCI 605 may include a first indication of the one or more TCI states for the UE 115 to use for communications with the base station 105 and a second indication that activates one or more SPS PDSCHs 610. Additionally, the UE 115 may be configured to transmit ACK/NACK feedback for each of the one or more SPS PDSCHs 610. In some implementations, the UE 115 may begin TCI state-based communications 615 with the base station 105 (for example, using at least one TCI state of the one or more indicated TCI states) after a delay 620 in a first slot (or different length TTI) that is at least X ms or Y symbols after the DCI 605 with the first indication of the one or more TCI states is received.

Additionally or alternatively, the UE 115 and the base station 105 may use transmission of ACK/NACK feedback for at least one of the one or more SPS PDSCHs 610 as an implicit acknowledgment for the first indication of the one or more TCI states and may initiate a delay 625 upon transmission of the ACK/NACK feedback for the at least one of the one or more SPS PDSCHs 610s. That is, ACK/NACK feedback for an SPS PDSCH may be used as an acknowledgment indication of the one or more TCI states if the DCI 605 carrying the first indication of the one or more TCI states also schedules the one or more SPS PDSCHs 610s. Subsequently, the UE 115 may apply an indicated TCI state for the TCI state-based communications 615 in a first slot that is at least X ms or Y symbols from one (for example, a first or last) symbol of an ACK/NACK feedback transmission for an SPS PDSCH or from one (for example, a first or last) symbol of one (for example, an actual or a nominal) transmission of multiple ACK/NACK feedback transmissions for the one or more SPS PDSCHs 610s scheduled by the DCI 605.

For example, the UE 115 may use a delay 625-a that begins from a first symbol of an ACK/NACK feedback transmission for a first SPS PDSCH scheduled by the DCI 605 before applying the indicated TCI state for the TCI state-based communications 615. Alternatively, the UE 115 may use a delay 625-b that begins from a last symbol of an ACK/NACK feedback transmission for a last SPS PDSCH scheduled by the DCI 605 before applying the indicated TCI state for the TCI state-based communications 615. Although the delay 625-a and the delay 625-b are shown in the example of FIG. 6, various different delays may be used, such as different delays beginning from first or last symbols of other ACK/NACK feedback transmissions for SPS PDSCHs scheduled by the DCI 605 may be used.

FIG. 7 illustrates an example of a timeline 700 that supports acknowledgment indications for DCI-based transmissions in accordance with aspects of the present disclosure. The timeline 700 may implement aspects of or may be implemented by aspects of the wireless communications systems 100 and 200. For example, a UE 115 and a base station 105 may use the timeline 700 to determine when the UE 115 is to start using one or more TCI states (for example, beams) indicated by the base station 105 for communications with the base station 105. The UE 115 may begin using the one or more TCI states after a delay that begins after receiving an indication of the one or more TCI states or transmitting an uplink transmission corresponding to the same indication that carries the one or more TCI states.

In the example of FIG. 7, the base station 105 may transmit a DCI 705 to the UE 115, and the DCI 705 may include a first indication of the one or more TCI states for the UE 115 to use for communications with the base station 105 and a second indication for an activation (or deactivation) of an uplink configured grant (for example, configured grant type II activation or deactivation). For example, the activation of the uplink configured grant may activate one or more configured grant (CG) PUSCHs 710 that the UE 115 can use to transmit uplink messages to the base station 105. In some implementations, the UE 115 may begin TCI state-based communications 715 with the base station 105 (for example, using at least one TCI state of the one or more indicated TCI states) after a delay 720 in a first slot (or different length TTI) that is at least X ms or Y symbols after the DCI 705 with the first indication of the one or more TCI states is received.

Additionally or alternatively, the UE 115 and the base station 105 may use transmission of a confirmation message 735 or transmission of at least one of the one or more configured grant PUSCHs 710 as an implicit acknowledgment for the first indication of the one or more TCI states. Subsequently, the UE 115 and the base station 105 may initiate a delay 725 upon transmission of the confirmation message 735 or may initiate a delay 730 upon transmission of the at least one of the one or more configured grant PUSCHs 710. That is, a confirmation message transmission or a configured grant PUSCH transmission may be used as an acknowledgment indication of the one or more TCI states if the DCI 705 carrying the first indication of the one or more TCI states also activates the one or more configured grant PUSCHs 710. In some implementations, the confirmation message 735 may be a configured grant confirmation MAC-CE transmission that the UE 115 transmits to acknowledge that the one or more configured grant PUSCHs 710 have been activated (or deactivated).

The UE 115 may apply an indicated TCI state for the TCI state-based communications 715 in a first slot that is at least X ms or Y symbols from one (for example, a first or last) symbol of the confirmation message 735 or from one (for example, a first or last) symbol of one (for example, a first) configured grant PUSCH transmission (for example, configured grant type II PUSCH transmission) activated by the DCI 705. For example, the UE 115 may use a delay 725 that begins from a last symbol of the confirmation message 735 before applying the indicated TCI state for the TCI state-based communications 715. Additionally or alternatively, the UE 115 may use a delay 730 that begins from a last symbol of a first configured grant PUSCH activated by the DCI 705 before applying the indicated TCI state for the TCI state-based communications 715. In some implementations, the base station 105 and the UE 115 may use the delay 725 or the delay 730 based on which of the confirmation message 735 or the first configured grant PUSCH transmission occurs first or last. Although the delay 725 and the delay 730 are shown in the example of FIG. 7, that different delays beginning from first or last symbols of the confirmation message 735, the first configured grant PUSCH transmission, or other configured grant PUSCHs activated by the DCI 705 may be used.

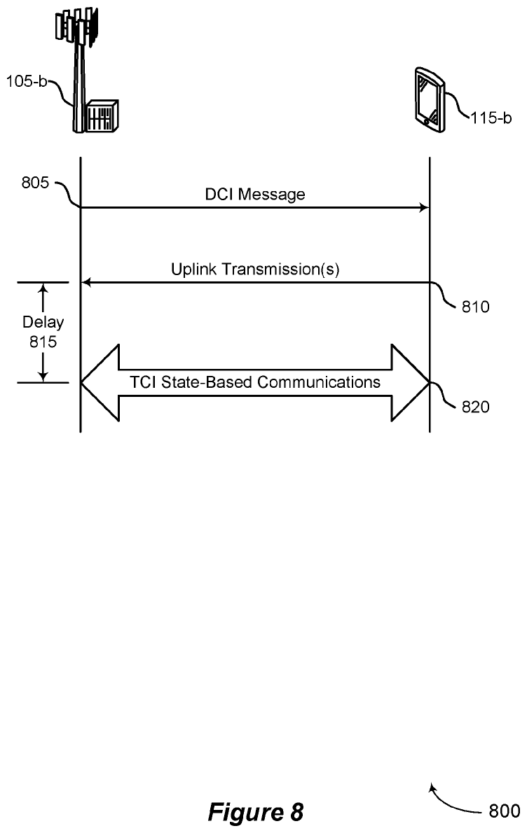

FIG. 8 illustrates an example of a process flow 800 that supports acknowledgment indications for DCI-based transmissions in accordance with aspects of the present disclosure. In some examples, process flow 800 may implement aspects of or may be implemented by aspects of the wireless communications systems 100 and 200. Process flow 800 may include a base station 105-b and a UE 115-b, which may be examples of corresponding base stations 105 and UEs 115, respectively, as described above with reference to FIGS. 1-7.

In the following description of the process flow 800, the operations between the UE 115-b and base station 105-b may be performed in different orders or at different times. Certain operations may also be left out of the process flow 800, or other operations may be added to the process flow 800. It is to be understood that although UE 115-b and base station 105-b are shown performing a number of the operations of process flow 800, any wireless device may perform the operations shown.

At 805, the UE 115-b may receive, from the base station 105-b, a DCI message including a first indication of one or more TCI states for communications with the base station 105-b and a second indication corresponding to one or more uplink transmissions for transmitting to the base station 105-b.

At 810, the UE 115-b may transmit, to the base station 105-b, at least one of the one or more uplink transmissions based on receiving the DCI including the second indication.

At 820, the UE 115-b may communicate with the base station 105-b using the one or more TCI states and after a delay 815, the delay 815 initiated based on transmitting the at least one of the one or more uplink transmissions. In some examples, the delay 815 may include an amount of time or a quantity of symbols between transmitting the at least one of the one or more uplink transmissions and communicating with the base station 105-b using the one or more TCI states. Additionally, the delay may be initiated after a starting symbol of the at least one of the one or more uplink transmissions or after an ending symbol of the at least one of the one or more uplink transmissions.

In some implementations, the UE 115-b may receive the DCI message including the second indication scheduling one or more uplink shared channel transmissions (for example, as described with reference to FIG. 3), in which the at least one of the one or more uplink transmissions includes at least one of the one or more uplink shared channel transmissions and the delay is initiated based on transmitting the at least one of the one or more uplink shared channel transmissions.

In some implementations, the UE 115-b may receive the DCI message including the second indication scheduling one or more SRS transmissions (for example, as described with reference to FIG. 4), in which the at least one of the one or more uplink transmissions includes at least one of the one or more SRS transmissions and the delay is initiated based on transmitting the at least one of the one or more SRS transmissions. In some examples, the at least one of the one or more SRS transmissions includes a lowest resource set ID of a set of resource set IDs or a highest resource set ID of the set of resource set IDs, each of the set of resource set IDs corresponding to a respective SRS transmission of the one or more SRS transmissions.

In some implementations, the UE 115-b may receive the DCI message including the second indication scheduling one or more CSI reports (for example, as described with reference to FIG. 5), in which the at least one of the one or more uplink transmissions includes at least one of the one or more CSI reports and the delay is initiated based on transmitting the at least one of the one or more CSI reports. Additionally or alternatively, the UE 115-b may receive an additional DCI message including the first indication of the one or more TCI states for communications with the base station 105-b and an additional indication to perform a CSI measurement operation, and the UE 115-b may refrain from communicating with the base station 105-b using the one or more TCI states based on the additional indication in the additional DCI message including the additional indication to perform the CSI measurement operation.

In some implementations, the UE 115-b may receive the DCI message including the second indication scheduling one or more SPS downlink channel reception opportunities (for example, as described with reference to FIG. 6), in which the at least one of the one or more uplink transmissions includes an acknowledgment feedback message for at least one of the one or more SPS downlink channel reception opportunities and the delay is initiated based on transmitting the acknowledgment feedback message.

In some implementations, the UE 115-b may receive the DCI message including the second indication that includes an activation indication for one or more configured grant uplink transmissions (for example, as described with reference to FIG. 7), in which the at least one of the one or more uplink transmissions includes a confirmation message for the activation indication or the at least one of the one or more uplink transmissions includes at least one of the one or more configured grant uplink transmissions and the delay is initiated based on transmitting the confirmation message or the at least one of the one or more configured grant uplink transmissions. For example, the confirmation message may include a configured grant confirmation MAC-CE transmission confirming the reception of the DCI message activating the one or more configured grant uplink transmissions.

In some implementations, the UE 115-b may receive an additional DCI message including the first indication of the one or more TCI states for communications with the base station and an additional indication of a dormancy for an SCell of the UE. In some examples, the UE 115-b may refrain from communicating with the base station 105-b using the one or more TCI states based on the additional indication in the additional DCI message including the additional indication of the dormancy for the SCell of the UE and no downlink shared channel receptions occurring on the SCell.

In some implementations, the UE 115-b may receive the DCI message including the second indication scheduling the one or more uplink transmissions in respective transmission opportunities, in which the delay is initiated based on a transmission opportunity of the respective transmission opportunities.

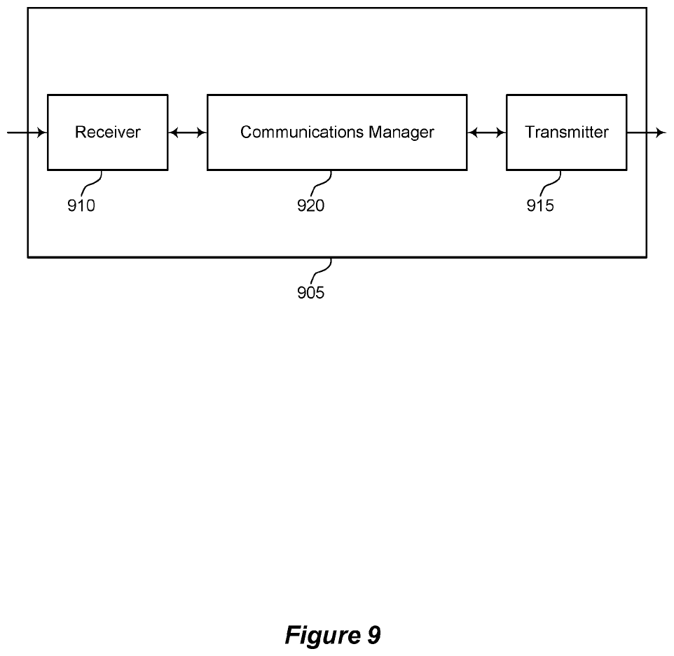

FIG. 9 shows a block diagram of a device 905 that supports acknowledgment indications for DCI-based transmissions in accordance with aspects of the present disclosure. The device 905 may be an example of aspects of a UE 115 as described herein. The device 905 may include a receiver 910, a transmitter 915, and a communications manager 920. The communications manager 920 can be implemented, at least in part, by one or both of a modem and a processor. Each of these components may be in communication with one another (for example, via one or more buses).

The receiver 910 may provide a means for receiving information such as packets, user data, control information, or any combination thereof associated with various information channels (for example, control channels, data channels, information channels related to acknowledgment indications for DCI-based transmissions). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (for example, control channels, data channels, information channels related to acknowledgment indications for DCI-based transmissions). In some examples, the transmitter 915 may be co-located with a receiver 910 in a transceiver component. The transmitter 915 may utilize a single antenna or a set of multiple antennas.

The communications manager 920, the receiver 910, the transmitter 915, or various combinations thereof or various components thereof may be examples of means for performing various aspects of acknowledgment indications for DCI-based transmissions as described herein. For example, the communications manager 920, the receiver 910, the transmitter 915, or various combinations or components thereof may support a method for performing one or more of the functions described herein.

Additionally or alternatively, in some examples, the communications manager 920, the receiver 910, the transmitter 915, or various combinations or components thereof may be implemented in code (for example, as communications management software or firmware) executed by a processor. If implemented in code executed by a processor, the functions of the communications manager 920, the receiver 910, the transmitter 915, or various combinations or components thereof may be performed by a general-purpose processor, a digital signal processor (DSP), a central processing unit (CPU), an application-specific integrated circuit (ASIC), a field-programmable gate array (FPGA), or any combination of these or other programmable logic devices (for example, configured as or otherwise supporting a means for performing the functions described in the present disclosure).

In some examples, the communications manager 920 may be configured to perform various operations (for example, receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a UE in accordance with examples as disclosed herein. For example, the communications manager 920 may be configured as or otherwise support a means for receiving, from a base station, a DCI message including a first indication of one or more TCI states for communications with the base station and a second indication corresponding to one or more uplink transmissions for transmitting to the base station. The communications manager 920 may be configured as or otherwise support a means for transmitting, to the base station, at least one of the one or more uplink transmissions based on receiving the DCI including the second indication. The communications manager 920 may be configured as or otherwise support a means for communicating with the base station using the one or more TCI states and after a delay, the delay initiated based on transmitting the at least one of the one or more uplink transmissions.

By including or configuring the communications manager 920 in accordance with examples as described herein, the device 905 (for example, a processor controlling or otherwise coupled to the receiver 910, the transmitter 915, the communications manager 920, or any combination thereof) may support techniques for more efficient utilization of communication resources. For example, rather than transmitting an explicit acknowledgment message for the first indication of the one or more TCI states for communications with the base station received in the DCI, the device 905 may implicitly acknowledge that first indication for initiating the delay based on transmitting an uplink message that corresponds to the second indication received in the DCI, thereby saving resources and signaling overhead.

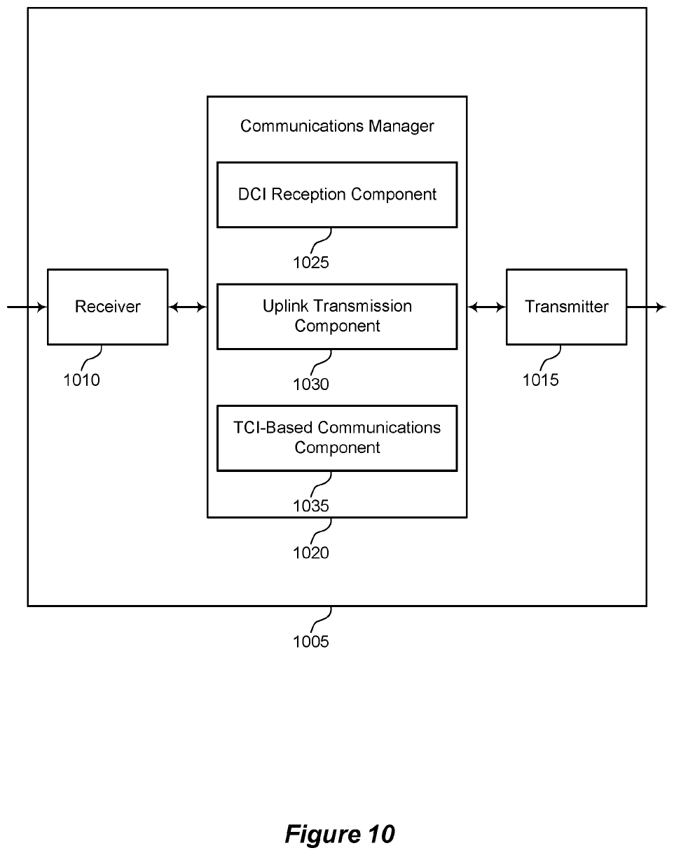

FIG. 10 shows a block diagram of a device 1005 that supports acknowledgment indications for DCI-based transmissions in accordance with aspects of the present disclosure. The device 1005 may be an example of aspects of a device 905 or a UE 115 as described herein. The device 1005 may include a receiver 1010, a transmitter 1015, and a communications manager 1020. The communications manager 1020 can be implemented, at least in part, by one or both of a modem and a processor. Each of these components may be in communication with one another (for example, via one or more buses).

The receiver 1010 may provide a means for receiving information such as packets, user data, control information, or any combination thereof associated with various information channels (for example, control channels, data channels, information channels related to acknowledgment indications for DCI-based transmissions). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (for example, control channels, data channels, information channels related to acknowledgment indications for DCI-based transmissions). In some examples, the transmitter 1015 may be co-located with a receiver 1010 in a transceiver component. The transmitter 1015 may utilize a single antenna or a set of multiple antennas.

The device 1005, or various components thereof, may be an example of means for performing various aspects of acknowledgment indications for DCI-based transmissions as described herein. For example, the communications manager 1020 may include a DCI reception component 1025, an uplink transmission component 1030, a TCI-based communication component 1035, or any combination thereof. In some examples, the communications manager 1020, or various components thereof, may be configured to perform various operations (for example, receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a UE in accordance with examples as disclosed herein. The DCI reception component 1025 may be configured as or otherwise support a means for receiving, from a base station, a DCI message including a first indication of one or more TCI states for communications with the base station and a second indication corresponding to one or more uplink transmissions for transmitting to the base station. The uplink transmission component 1030 may be configured as or otherwise support a means for transmitting, to the base station, at least one of the one or more uplink transmissions based on receiving the DCI including the second indication. The TCI-based communication component 1035 may be configured as or otherwise support a means for communicating with the base station using the one or more TCI states and after a delay, the delay initiated based on transmitting the at least one of the one or more uplink transmissions.

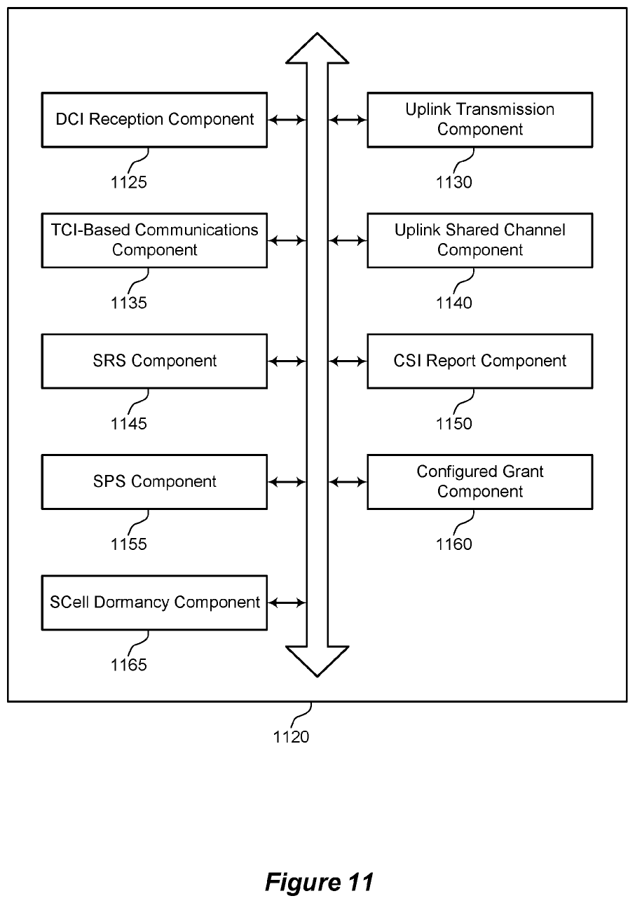

FIG. 11 shows a block diagram of a communications manager 1120 that supports acknowledgment indications for DCI-based transmissions in accordance with aspects of the present disclosure. The communications manager 1120, or various components thereof, may be an example of means for performing various aspects of acknowledgment indications for DCI-based transmissions as described herein. For example, the communications manager 1120 may include a DCI reception component 1125, an uplink transmission component 1130, a TCI-based communication component 1135, an uplink shared channel component 1140, an SRS component 1145, a CSI report component 1150, an SPS component 1155, a configured grant component 1160, an SCell dormancy component 1165, or any combination thereof. Each of these components may communicate, directly or indirectly, with one another (for example, via one or more buses).

The communications manager 1120 may support wireless communications at a UE in accordance with examples as disclosed herein. The DCI reception component 1125 may be configured as or otherwise support a means for receiving, from a base station, a DCI message including a first indication of one or more TCI states for communications with the base station and a second indication corresponding to one or more uplink transmissions for transmitting to the base station. The uplink transmission component 1130 may be configured as or otherwise support a means for transmitting, to the base station, at least one of the one or more uplink transmissions based on receiving the DCI including the second indication. The TCI-based communication component 1135 may be configured as or otherwise support a means for communicating with the base station using the one or more TCI states and after a delay, the delay initiated based on transmitting the at least one of the one or more uplink transmissions.

In some examples, to support receiving the DCI message, the uplink shared channel component 1140 may be configured as or otherwise support a means for receiving the DCI message including the second indication scheduling one or more uplink shared channel transmissions, in which the at least one of the one or more uplink transmissions includes at least one of the one or more uplink shared channel transmissions and the delay is initiated based on transmitting the at least one of the one or more uplink shared channel transmissions.

In some examples, to support receiving the DCI message, the SRS component 1145 may be configured as or otherwise support a means for receiving the DCI message including the second indication scheduling one or more SRS transmissions, in which the at least one of the one or more uplink transmissions includes at least one of the one or more SRS transmissions and the delay is initiated based on transmitting the at least one of the one or more SRS transmissions.

In some examples, the at least one of the one or more SRS transmissions includes a lowest resource set ID of a set of multiple resource set IDs or a highest resource set ID of the set of multiple resource set IDs, each of the set of multiple resource set IDs corresponding to a respective SRS transmission of the one or more SRS transmissions.

In some examples, to support receiving the DCI message, the CSI report component 1150 may be configured as or otherwise support a means for receiving the DCI message including the second indication scheduling one or more CSI reports, in which the at least one of the one or more uplink transmissions includes at least one of the one or more CSI reports and the delay is initiated based on transmitting the at least one of the one or more CSI reports.

In some examples, the CSI report component 1150 may be configured as or otherwise support a means for receiving an additional DCI message including the first indication of the one or more TCI states for communications with the base station and an additional indication to perform a CSI measurement operation. In some examples, the CSI report component 1150 may be configured as or otherwise support a means for refraining from communicating with the base station using the one or more TCI states based on the additional indication in the additional DCI message including the additional indication to perform the CSI measurement operation.

In some examples, to support receiving the DCI message, the SPS component 1155 may be configured as or otherwise support a means for receiving the DCI message including the second indication scheduling one or more SPS downlink channel reception opportunities, in which the at least one of the one or more uplink transmissions includes an acknowledgment feedback message for at least one of the one or more SPS downlink channel reception opportunities and the delay is initiated based on transmitting the acknowledgment feedback message.

In some examples, to support receiving the DCI message, the configured grant component 1160 may be configured as or otherwise support a means for receiving the DCI message including the second indication that includes an activation indication for one or more configured grant uplink transmissions, in which the at least one of the one or more uplink transmissions includes a confirmation message for the activation indication or the at least one of the one or more uplink transmissions includes at least one of the one or more configured grant uplink transmissions and the delay is initiated based on transmitting the confirmation message or the at least one of the one or more configured grant uplink transmissions.

In some examples, the confirmation message includes a configured grant confirmation MAC-CE transmission confirming the reception of the DCI message activating the one or more configured grant uplink transmissions.

In some examples, the SCell dormancy component 1165 may be configured as or otherwise support a means for receiving an additional DCI message including the first indication of the one or more TCI states for communications with the base station and an additional indication of a dormancy for a SCell of the UE. In some examples, the SCell dormancy component 1165 may be configured as or otherwise support a means for refraining from communicating with the base station using the one or more TCI states based on the additional indication in the additional DCI message including the additional indication of the dormancy for the SCell of the UE and no downlink shared channel receptions occurring on the SCell.

In some examples, to support receiving the DCI message, the DCI reception component 1125 may be configured as or otherwise support a means for receiving the DCI message including the second indication scheduling the one or more uplink transmissions in respective transmission opportunities, in which the delay is initiated based on a transmission opportunity of the respective transmission opportunities.

In some examples, the delay includes an amount of time or a quantity of symbols between transmitting the at least one of the one or more uplink transmissions and communicating with the base station using the one or more TCI states.

In some examples, the delay is initiated after a starting symbol of the at least one of the one or more uplink transmissions or after an ending symbol of the at least one of the one or more uplink transmissions.

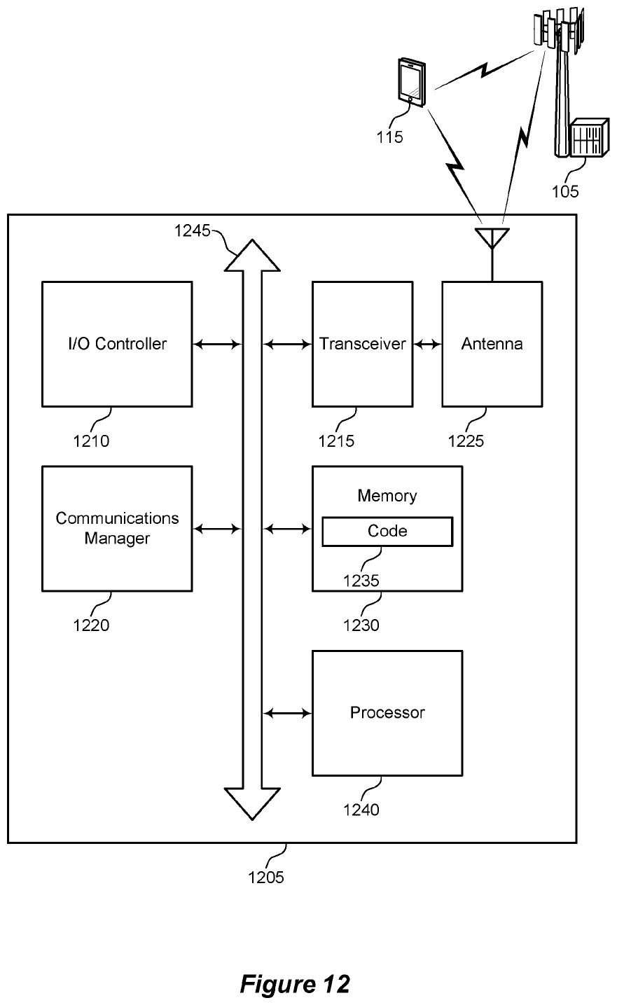

FIG. 12 shows a diagram of a system including a device 1205 that supports acknowledgment indications for DCI-based transmissions in accordance with aspects of the present disclosure. The device 1205 may be an example of or include the components of a device 905, a device 1005, or a UE 115 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, an input/output (I/O) controller 1210, a transceiver 1215, an antenna 1225, a memory 1230, code 1235, and a processor 1240. These components may be in electronic communication or otherwise coupled (for example, operatively, communicatively, functionally, electronically, electrically) via one or more buses (for example, a bus 1245).

The I/O controller 1210 may manage input and output signals for the device 1205. The I/O controller 1210 may also manage peripherals not integrated into the device 1205. In some cases, the I/O controller 1210 may represent a physical connection or port to an external peripheral. In some cases, the I/O controller 1210 may utilize an operating system such as iOS®, ANDROID®, MS-DOS®, MS-WINDOWS®, OS/2®, UNIX®, LINUX®, or another known operating system. Additionally or alternatively, the I/O controller 1210 may represent or interact with a modem, a keyboard, a mouse, a touchscreen, or a similar device. In some cases, the I/O controller 1210 may be implemented as part of a processor, such as the processor 1240. In some cases, a user may interact with the device 1205 via the I/O controller 1210 or via hardware components controlled by the I/O controller 1210.

In some cases, the device 1205 may include a single antenna 1225. However, in some other cases, the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include random access memory (RAM) and read-only memory (ROM). The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (for example, when compiled and executed) to perform functions described herein. In some cases, the memory 1230 may contain, among other things, a basic I/O system (BIOS) which may control basic hardware or software operation such as the interaction with peripheral components or devices.

The processor 1240 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (for example, the memory 1230) to cause the device 1205 to perform various functions (for example, functions or tasks supporting acknowledgment indications for DCI-based transmissions). For example, the device 1205 or a component of the device 1205 may include a processor 1240 and memory 1230 coupled to the processor 1240, the processor 1240 and memory 1230 configured to perform various functions described herein.

The communications manager 1220 may support wireless communications at a UE in accordance with examples as disclosed herein. For example, the communications manager 1220 may be configured as or otherwise support a means for receiving, from a base station, a DCI message including a first indication of one or more TCI states for communications with the base station and a second indication corresponding to one or more uplink transmissions for transmitting to the base station. The communications manager 1220 may be configured as or otherwise support a means for transmitting, to the base station, at least one of the one or more uplink transmissions based on receiving the DCI including the second indication. The communications manager 1220 may be configured as or otherwise support a means for communicating with the base station using the one or more TCI states and after a delay, the delay initiated based on transmitting the at least one of the one or more uplink transmissions.

By including or configuring the communications manager 1220 in accordance with examples as described herein, the device 1205 may support techniques for improved communication reliability, reduced latency, and more efficient utilization of communication resources. For example, by acknowledging the second indication by transmitting an uplink transmission scheduled by the same DCI that carries the second indication, a processor of the device 1205 may improve communication reliability by using the indicated TCI states after a delay initiated by transmitting the uplink transmission, as well as may reduce latency and more efficiently use communication resources based on not transmitting a dedicated acknowledgment message for the second indication.

In some examples, the communications manager 1220 may be configured to perform various operations (for example, receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of acknowledgment indications for DCI-based transmissions as described herein, or the processor 1240 and the memory 1230 may be otherwise configured to perform or support such operations.

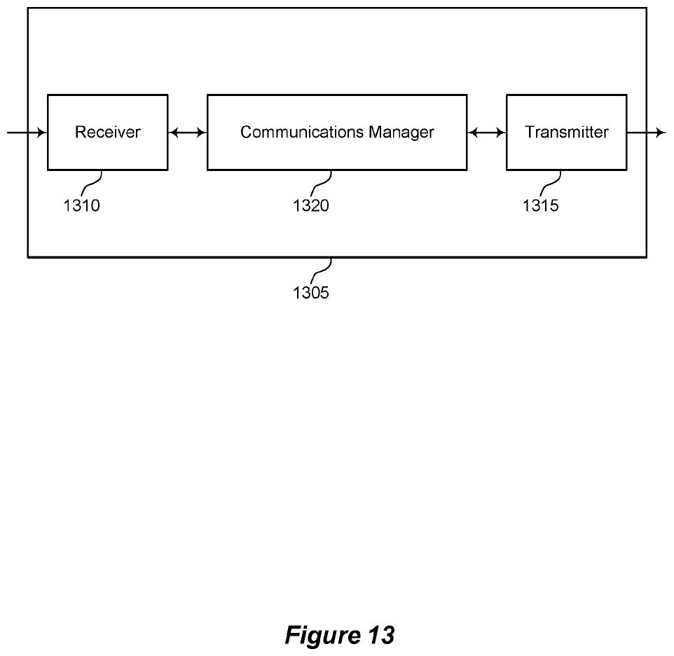

FIG. 13 shows a block diagram of a device 1305 that supports acknowledgment indications for DCI-based transmissions in accordance with aspects of the present disclosure. The device 1305 may be an example of aspects of a base station 105 as described herein. The device 1305 may include a receiver 1310, a transmitter 1315, and a communications manager 1320. The communications manager 1320 can be implemented, at least in part, by one or both of a modem and a processor. Each of these components may be in communication with one another (for example, via one or more buses).

The receiver 1310 may provide a means for receiving information such as packets, user data, control information, or any combination thereof associated with various information channels (for example, control channels, data channels, information channels related to acknowledgment indications for DCI-based transmissions). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (for example, control channels, data channels, information channels related to acknowledgment indications for DCI-based transmissions). In some examples, the transmitter 1315 may be co-located with a receiver 1310 in a transceiver component. The transmitter 1315 may utilize a single antenna or a set of multiple antennas.

The communications manager 1320, the receiver 1310, the transmitter 1315, or various combinations thereof or various components thereof may be examples of means for performing various aspects of acknowledgment indications for DCI-based transmissions as described herein. For example, the communications manager 1320, the receiver 1310, the transmitter 1315, or various combinations or components thereof may support a method for performing one or more of the functions described herein.

Additionally or alternatively, in some examples, the communications manager 1320, the receiver 1310, the transmitter 1315, or various combinations or components thereof may be implemented in code (for example, as communications management software or firmware) executed by a processor. If implemented in code executed by a processor, the functions of the communications manager 1320, the receiver 1310, the transmitter 1315, or various combinations or components thereof may be performed by a general-purpose processor, a DSP, a CPU, an ASIC, an FPGA, or any combination of these or other programmable logic devices (for example, configured as or otherwise supporting a means for performing the functions described in the present disclosure).

In some examples, the communications manager 1320 may be configured to perform various operations (for example, receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station in accordance with examples as disclosed herein. For example, the communications manager 1320 may be configured as or otherwise support a means for transmitting, to a UE, a DCI message including a first indication of one or more TCI states for the UE to use for communications with the base station and a second indication corresponding to one or more uplink transmissions for the UE to transmit to the base station. The communications manager 1320 may be configured as or otherwise support a means for receiving, from the UE, at least one of the one or more uplink transmissions based on transmitting the DCI including the second indication. The communications manager 1320 may be configured as or otherwise support a means for communicating with the UE using the one or more TCI states and after a delay, the delay initiated based on receiving the at least one of the one or more uplink transmissions.

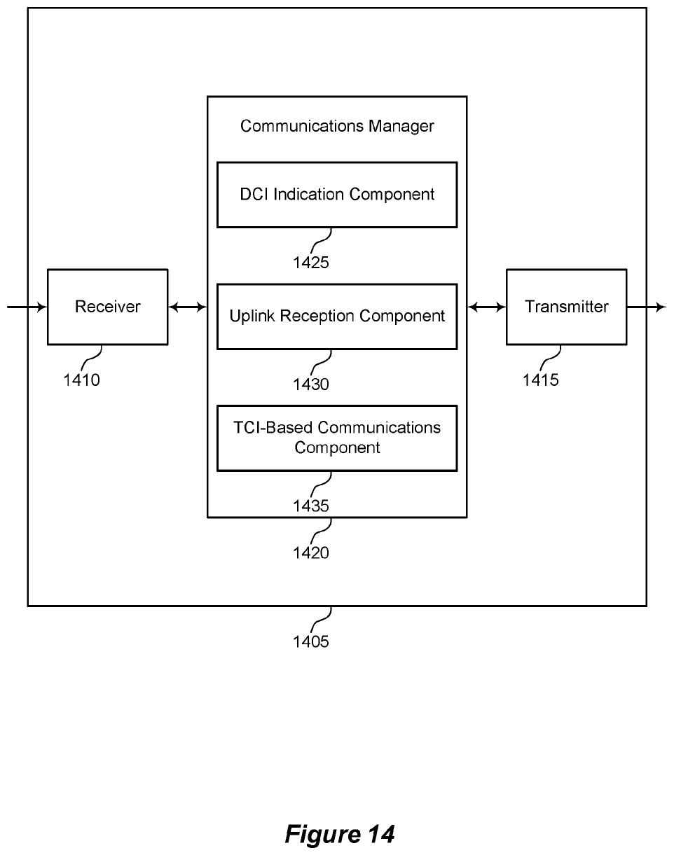

FIG. 14 shows a block diagram of a device 1405 that supports acknowledgment indications for DCI-based transmissions in accordance with aspects of the present disclosure. The device 1405 may be an example of aspects of a device 1305 or a base station 105 as described herein. The device 1405 may include a receiver 1410, a transmitter 1415, and a communications manager 1420. The communications manager 1420 can be implemented, at least in part, by one or both of a modem and a processor. Each of these components may be in communication with one another (for example, via one or more buses).

The receiver 1410 may provide a means for receiving information such as packets, user data, control information, or any combination thereof associated with various information channels (for example, control channels, data channels, information channels related to acknowledgment indications for DCI-based transmissions). Information may be passed on to other components of the device 1405. The receiver 1410 may utilize a single antenna or a set of multiple antennas.

The transmitter 1415 may provide a means for transmitting signals generated by other components of the device 1405. For example, the transmitter 1415 may transmit information such as packets, user data, control information, or any combination thereof associated with various information channels (for example, control channels, data channels, information channels related to acknowledgment indications for DCI-based transmissions). In some examples, the transmitter 1415 may be co-located with a receiver 1410 in a transceiver component. The transmitter 1415 may utilize a single antenna or a set of multiple antennas.

The device 1405, or various components thereof, may be an example of means for performing various aspects of acknowledgment indications for DCI-based transmissions as described herein. For example, the communications manager 1420 may include a DCI indication component 1425, an uplink reception component 1430, a TCI-based communication component 1435, or any combination thereof. In some examples, the communications manager 1420, or various components thereof, may be configured to perform various operations (for example, receiving, monitoring, transmitting) using or otherwise in cooperation with the receiver 1410, the transmitter 1415, or both. For example, the communications manager 1420 may receive information from the receiver 1410, send information to the transmitter 1415, or be integrated in combination with the receiver 1410, the transmitter 1415, or both to receive information, transmit information, or perform various other operations as described herein.

The communications manager 1420 may support wireless communications at a base station in accordance with examples as disclosed herein. The DCI indication component 1425 may be configured as or otherwise support a means for transmitting, to a UE, a DCI message including a first indication of one or more TCI states for the UE to use for communications with the base station and a second indication corresponding to one or more uplink transmissions for the UE to transmit to the base station. The uplink reception component 1430 may be configured as or otherwise support a means for receiving, from the UE, at least one of the one or more uplink transmissions based on transmitting the DCI including the second indication. The TCI-based communication component 1435 may be configured as or otherwise support a means for communicating with the UE using the one or more TCI states and after a delay, the delay initiated based on receiving the at least one of the one or more uplink transmissions.

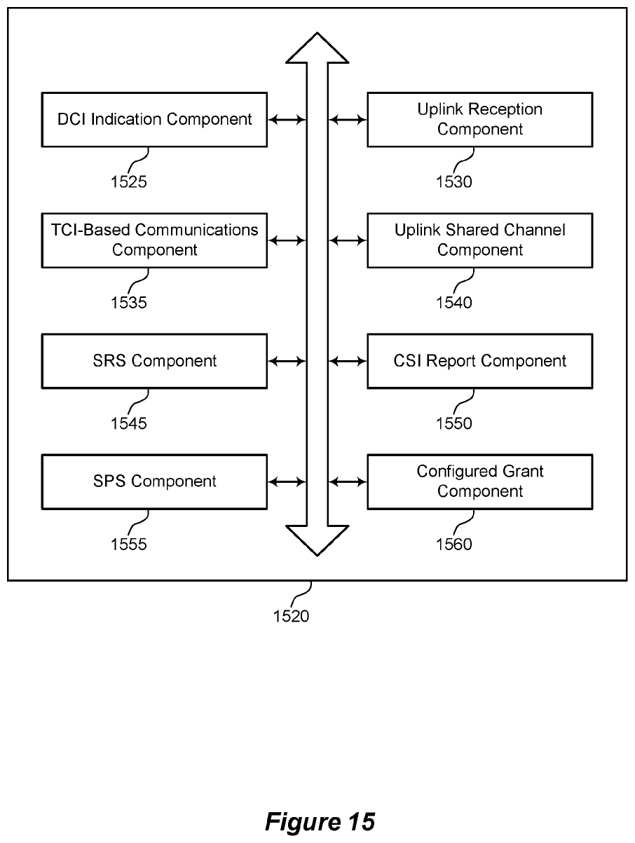

FIG. 15 shows a block diagram of a communications manager 1520 that supports acknowledgment indications for DCI-based transmissions in accordance with aspects of the present disclosure. The communications manager 1520, or various components thereof, may be an example of means for performing various aspects of acknowledgment indications for DCI-based transmissions as described herein. For example, the communications manager 1520 may include a DCI indication component 1525, an uplink reception component 1530, a TCI-based communication component 1535, an uplink shared channel component 1540, an SRS component 1545, a CSI report component 1550, an SPS component 1555, a configured grant component 1560, or any combination thereof. Each of these components may communicate, directly or indirectly, with one another (for example, via one or more buses).

The communications manager 1520 may support wireless communications at a base station in accordance with examples as disclosed herein. The DCI indication component 1525 may be configured as or otherwise support a means for transmitting, to a UE, a DCI message including a first indication of one or more TCI states for the UE to use for communications with the base station and a second indication corresponding to one or more uplink transmissions for the UE to transmit to the base station. The uplink reception component 1530 may be configured as or otherwise support a means for receiving, from the UE, at least one of the one or more uplink transmissions based on transmitting the DCI including the second indication. The TCI-based communication component 1535 may be configured as or otherwise support a means for communicating with the UE using the one or more TCI states and after a delay, the delay initiated based on receiving the at least one of the one or more uplink transmissions.

In some examples, to support transmitting the DCI message, the uplink shared channel component 1540 may be configured as or otherwise support a means for transmitting the DCI message including the second indication scheduling one or more uplink shared channel transmissions, in which the at least one of the one or more uplink transmissions includes at least one of the one or more uplink shared channel transmissions and the delay is initiated based on receiving the at least one of the one or more uplink shared channel transmissions.

In some examples, to support transmitting the DCI message, the SRS component 1545 may be configured as or otherwise support a means for transmitting the DCI message including the second indication scheduling one or more SRS transmissions, in which the at least one of the one or more uplink transmissions includes at least one of the one or more SRS transmissions and the delay is initiated based on receiving the at least one of the one or more SRS transmissions.

In some examples, the at least one of the one or more SRS transmissions includes a lowest resource set ID of a set of multiple resource set IDs or a highest resource set ID of the set of multiple resource set IDs, each of the set of multiple resource set IDs corresponding to a respective SRS transmission of the one or more SRS transmissions.

In some examples, to support transmitting the DCI message, the CSI report component 1550 may be configured as or otherwise support a means for transmitting the DCI message including the second indication scheduling one or more CSI reports, in which the at least one of the one or more uplink transmissions includes at least one of the one or more CSI reports and the delay is initiated based on receiving the at least one of the one or more CSI reports.

In some examples, to support transmitting the DCI message, the SPS component 1555 may be configured as or otherwise support a means for transmitting the DCI message including the second indication scheduling one or more SPS downlink channel reception opportunities, in which the at least one of the one or more uplink transmissions includes an acknowledgment feedback message for at least one of the one or more SPS downlink channel reception opportunities and the delay is initiated based on receiving the acknowledgment feedback message.

In some examples, to support transmitting the DCI message, the configured grant component 1560 may be configured as or otherwise support a means for transmitting the DCI message including the second indication that includes an activation indication for one or more configured grant uplink transmissions, in which the at least one of the one or more uplink transmissions includes a confirmation message for the activation indication or the at least one of the one or more uplink transmissions includes at least one of the one or more configured grant uplink transmissions and the delay is initiated based on receiving the confirmation message or the at least one of the one or more configured grant uplink transmissions.

In some examples, the confirmation message includes a configured grant confirmation MAC-CE transmission confirming the reception of the DCI message activating the one or more configured grant uplink transmissions at the UE.

In some examples, to support transmitting the DCI message, the DCI indication component 1525 may be configured as or otherwise support a means for transmitting the DCI message including the second indication scheduling the one or more uplink transmissions in respective transmission opportunities, in which the delay is initiated based on a transmission opportunity of the respective transmission opportunities.

In some examples, the delay includes an amount of time or a quantity of symbols between receiving the at least one of the one or more uplink transmissions and communicating with the UE using the one or more TCI states.

In some examples, the delay is initiated after a starting symbol of the at least one of the one or more uplink transmissions or after an ending symbol of the at least one of the one or more uplink transmissions.

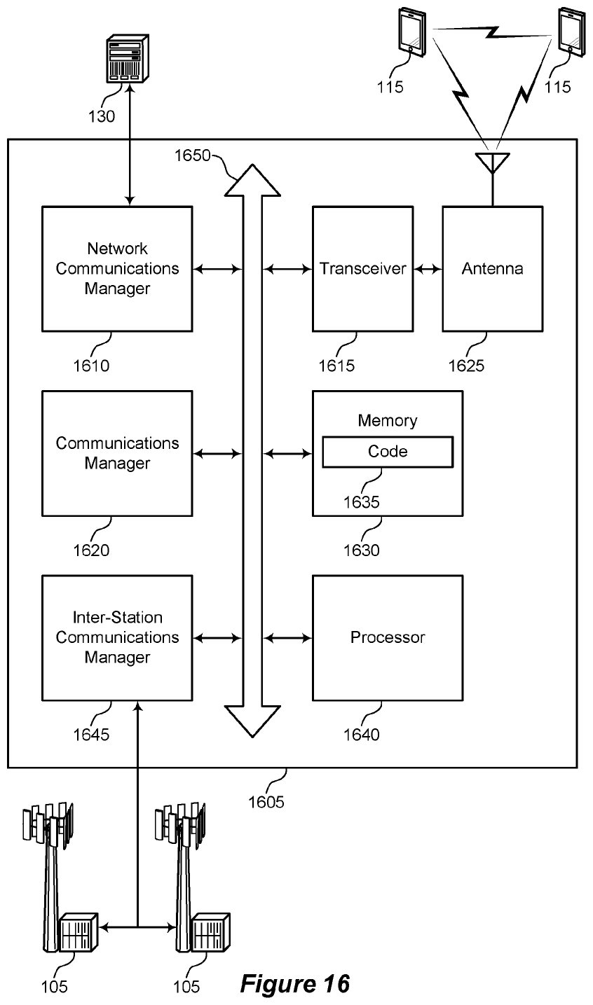

FIG. 16 shows a diagram of a system including a device 1605 that supports acknowledgment indications for DCI-based transmissions in accordance with aspects of the present disclosure. The device 1605 may be an example of or include the components of a device 1305, a device 1405, or a base station 105 as described herein. The device 1605 may communicate wirelessly with one or more base stations 105, UEs 115, or any combination thereof. The device 1605 may include components for bi-directional voice and data communications including components for transmitting and receiving communications, such as a communications manager 1620, a network communications manager 1610, a transceiver 1615, an antenna 1625, a memory 1630, code 1635, a processor 1640, and an inter-station communications manager 1645. These components may be in electronic communication or otherwise coupled (for example, operatively, communicatively, functionally, electronically, electrically) via one or more buses (for example, a bus 1650).

The network communications manager 1610 may manage communications with a core network 130 (for example, via one or more wired backhaul links). For example, the network communications manager 1610 may manage the transfer of data communications for client devices, such as one or more UEs 115.

In some cases, the device 1605 may include a single antenna 1625. However, in some other cases the device 1605 may have more than one antenna 1625, which may be capable of concurrently transmitting or receiving multiple wireless transmissions. The transceiver 1615 may communicate bi-directionally, via the one or more antennas 1625, wired, or wireless links as described herein. For example, the transceiver 1615 may represent a wireless transceiver and may communicate bi-directionally with another wireless transceiver. The transceiver 1615 may also include a modem to modulate the packets, to provide the modulated packets to one or more antennas 1625 for transmission, and to demodulate packets received from the one or more antennas 1625. The transceiver 1615, or the transceiver 1615 and one or more antennas 1625, may be an example of a transmitter 1315, a transmitter 1415, a receiver 1310, a receiver 1410, or any combination thereof or component thereof, as described herein.

The memory 1630 may include RAM and ROM. The memory 1630 may store computer-readable, computer-executable code 1635 including instructions that, when executed by the processor 1640, cause the device 1605 to perform various functions described herein. The code 1635 may be stored in a non-transitory computer-readable medium such as system memory or another type of memory. In some cases, the code 1635 may not be directly executable by the processor 1640 but may cause a computer (for example, when compiled and executed) to perform functions described herein. In some cases, the memory 1630 may contain, among other things, a BIOS which may control basic hardware or software operation such as the interaction with peripheral components or devices.

The processor 1640 may include an intelligent hardware device (for example, a general-purpose processor, a DSP, a CPU, a microcontroller, an ASIC, an FPGA, a programmable logic device, a discrete gate or transistor logic component, a discrete hardware component, or any combination thereof). In some cases, the processor 1640 may be configured to operate a memory array using a memory controller. In some other cases, a memory controller may be integrated into the processor 1640. The processor 1640 may be configured to execute computer-readable instructions stored in a memory (for example, the memory 1630) to cause the device 1605 to perform various functions (for example, functions or tasks supporting acknowledgment indications for DCI-based transmissions). For example, the device 1605 or a component of the device 1605 may include a processor 1640 and memory 1630 coupled to the processor 1640, the processor 1640 and memory 1630 configured to perform various functions described herein.

The inter-station communications manager 1645 may manage communications with other base stations 105, and may include a controller or scheduler for controlling communications with UEs 115 in cooperation with other base stations 105. For example, the inter-station communications manager 1645 may coordinate scheduling for transmissions to UEs 115 for various interference mitigation techniques such as beamforming or joint transmission. In some examples, the inter-station communications manager 1645 may provide an X2 interface within an LTE/LTE-A wireless communications network technology to provide communication between base stations 105.

The communications manager 1620 may support wireless communications at a base station in accordance with examples as disclosed herein. For example, the communications manager 1620 may be configured as or otherwise support a means for transmitting, to a UE, a DCI message including a first indication of one or more TCI states for the UE to use for communications with the base station and a second indication corresponding to one or more uplink transmissions for the UE to transmit to the base station. The communications manager 1620 may be configured as or otherwise support a means for receiving, from the UE, at least one of the one or more uplink transmissions based on transmitting the DCI including the second indication. The communications manager 1620 may be configured as or otherwise support a means for communicating with the UE using the one or more TCI states and after a delay, the delay initiated based on receiving the at least one of the one or more uplink transmissions.

In some examples, the communications manager 1620 may be configured to perform various operations (for example, receiving, monitoring, transmitting) using or otherwise in cooperation with the transceiver 1615, the one or more antennas 1625, or any combination thereof. Although the communications manager 1620 is illustrated as a separate component, in some examples, one or more functions described with reference to the communications manager 1620 may be supported by or performed by the processor 1640, the memory 1630, the code 1635, or any combination thereof. For example, the code 1635 may include instructions executable by the processor 1640 to cause the device 1605 to perform various aspects of acknowledgment indications for DCI-based transmissions as described herein, or the processor 1640 and the memory 1630 may be otherwise configured to perform or support such operations.

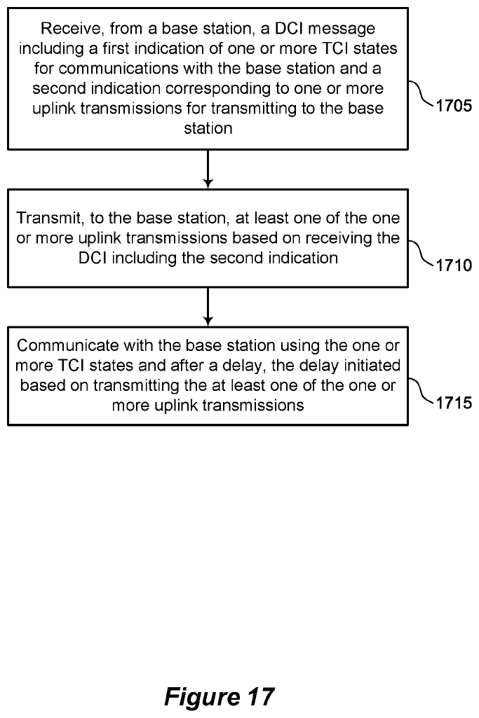

FIG. 17 shows a flowchart illustrating a method that supports acknowledgment indications for DCI-based transmissions in accordance with aspects of the present disclosure. The operations of the method may be implemented by a UE or its components as described herein. For example, the operations of the method may be performed by a UE 115 as described with reference to FIGS. 1-12. In some examples, a UE may execute a set of instructions to control the functional elements of the UE to perform the described functions. Additionally or alternatively, the UE may perform aspects of the described functions using special-purpose hardware.

At 1705, the method may include receiving, from a base station, a DCI message including a first indication of one or more TCI states for communications with the base station and a second indication corresponding to one or more uplink transmissions for transmitting to the base station. The operations of 1705 may be performed in accordance with examples as disclosed herein. In some examples, aspects of the operations of 1705 may be performed by a DCI reception component 1125 as described with reference to FIG. 11.

At 1710, the method may include transmitting, to the base station, at least one of the one or more uplink transmissions based on receiving the DCI including the second indication. The operations of 1710 may be performed in accordance with examples as disclosed herein. In some examples, aspects of the operations of 1710 may be performed by an uplink transmission component 1130 as described with reference to FIG. 11.

At 1715, the method may include communicating with the base station using the one or more TCI states and after a delay, the delay initiated based on transmitting the at least one of the one or more uplink transmissions. The operations of 1715 may be performed in accordance with examples as disclosed herein. In some examples, aspects of the operations of 1715 may be performed by a TCI-based communication component 1135 as described with reference to FIG. 11.

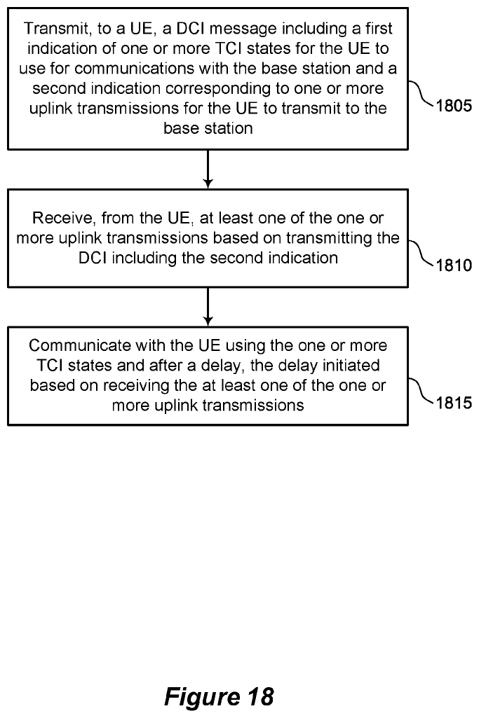

FIG. 18 shows a flowchart illustrating a method that supports acknowledgment indications for DCI-based transmissions in accordance with aspects of the present disclosure. The operations of the method may be implemented by a base station or its components as described herein. For example, the operations of the method may be performed by a base station 105 as described with reference to FIGS. 1-8 and 13-16. In some examples, a base station may execute a set of instructions to control the functional elements of the base station to perform the described functions. Additionally or alternatively, the base station may perform aspects of the described functions using special-purpose hardware.

At 1805, the method may include transmitting, to a UE, a DCI message including a first indication of one or more TCI states for the UE to use for communications with the base station and a second indication corresponding to one or more uplink transmissions for the UE to transmit to the base station. The operations of 1805 may be performed in accordance with examples as disclosed herein. In some examples, aspects of the operations of 1805 may be performed by a DCI indication component 1525 as described with reference to FIG. 15.

At 1810, the method may include receiving, from the UE, at least one of the one or more uplink transmissions based on transmitting the DCI including the second indication. The operations of 1810 may be performed in accordance with examples as disclosed herein. In some examples, aspects of the operations of 1810 may be performed by an uplink reception component 1530 as described with reference to FIG. 15.

At 1815, the method may include communicating with the UE using the one or more TCI states and after a delay, the delay initiated based on receiving the at least one of the one or more uplink transmissions. The operations of 1815 may be performed in accordance with examples as disclosed herein. In some examples, aspects of the operations of 1815 may be performed by a TCI-based communication component 1535 as described with reference to FIG. 15.

The following provides an overview of aspects of the present disclosure:
Aspect 1: A method for wireless communications at a UE, comprising: receiving, from a base station, a downlink control information message comprising a first indication of one or more transmission configuration indicator states for communications with the base station and a second indication corresponding to one or more uplink transmissions for transmitting to the base station; transmitting, to the base station, at least one of the one or more uplink transmissions based at least in part on receiving the downlink control information comprising the second indication; and communicating with the base station using the one or more transmission configuration indicator states and after a delay, the delay initiated based at least in part on transmitting the at least one of the one or more uplink transmissions.
Aspect 2: The method of aspect 1, wherein receiving the downlink control information message comprises: receiving the downlink control information message comprising the second indication scheduling one or more uplink shared channel transmissions, wherein the at least one of the one or more uplink transmissions comprises at least one of the one or more uplink shared channel transmissions and the delay is initiated based at least in part on transmitting the at least one of the one or more uplink shared channel transmissions.
Aspect 3: The method of aspect 1, wherein receiving the downlink control information message comprises: receiving the downlink control information message comprising the second indication scheduling one or more sounding reference signal transmissions, wherein the at least one of the one or more uplink transmissions comprises at least one of the one or more sounding reference signal transmissions and the delay is initiated based at least in part on transmitting the at least one of the one or more sounding reference signal transmissions.
Aspect 4: The method of aspect 3, wherein the at least one of the one or more sounding reference signals comprises a lowest resource set identifier of a plurality of resource set identifiers or a highest resource set identifier of the plurality of resource set identifiers, each of the plurality of resource set identifiers corresponding to a respective sounding reference signal of the one or more sounding reference signals.
Aspect 5: The method of aspect 1, wherein receiving the downlink control information message comprises: receiving the downlink control information message comprising the second indication scheduling one or more channel state information reports, wherein the at least one of the one or more uplink transmissions comprises at least one of the one or more channel state information reports and the delay is initiated based at least in part on transmitting the at least one of the one or more channel state information reports.
Aspect 6: The method of aspects 1 through 5, further comprising: receiving an additional downlink control information message comprising the first indication of the one or more transmission configuration indicator states for communications with the base station and an additional indication to perform a channel state information measurement operation; and refraining from communicating with the base station using the one or more transmission configuration indicator states based at least in part on the additional indication in the additional downlink control information message comprising the indication to perform the channel state information measurement operation.
Aspect 7: The method of aspect 1, wherein receiving the downlink control information message comprises: receiving the downlink control information message comprising the second indication scheduling one or more semi-persistent scheduling downlink channel reception opportunities, wherein the at least one of the one or more uplink transmissions comprises an acknowledgment feedback message for at least one of the one or more semi-persistent scheduling downlink channel reception opportunities and the delay is initiated based at least in part on transmitting the acknowledgment feedback message.
Aspect 8: The method of aspect 1, wherein receiving the downlink control information message comprises: receiving the downlink control information message comprising the second indication that includes an activation indication for one or more configured grant uplink transmissions, wherein the at least one of the one or more uplink transmissions comprises a confirmation message for the activation indication or the at least one of the one or more uplink transmissions comprises at least one of the one or more configured grant uplink transmissions and the delay is initiated based at least in part on transmitting the confirmation message or the at least one of the one or more configured grant uplink transmissions.
Aspect 9: The method of aspect 8, wherein the confirmation message comprises a configured grant confirmation medium access control control element transmission confirming the reception of the downlink control information message activating the one or more configured grant uplink transmissions.
Aspect 10: The method of any of aspects 1 through 9, further comprising: receiving an additional downlink control information message comprising the first indication of the one or more transmission configuration indicator states for communications with the base station and an additional indication of a dormancy for a secondary cell of the UE; and refraining from communicating with the base station using the one or more transmission configuration indicator states based at least in part on the additional indication in the additional downlink control information message comprising the indication of the dormancy for the secondary cell of the UE and no downlink shared channel receptions occurring on the secondary cell.
Aspect 11: The method of any of aspects 1 through 10, wherein receiving the downlink control information message comprises: receiving the downlink control information message comprising the second indication scheduling the one or more uplink transmissions in respective transmission opportunities, wherein the delay is initiated based at least in part on a transmission opportunity of the respective transmission opportunities.
Aspect 12: The method of any of aspects 1 through 11, wherein the delay comprises an amount of time or a quantity of symbols between transmitting the at least one of the one or more uplink transmissions and communicating with the base station using the one or more transmission configuration indicator states.
Aspect 13: The method of any of aspects 1 through 12, wherein the delay is initiated after a starting symbol of the at least one of the one or more uplink transmissions or after an ending symbol of the at least one of the one or more uplink transmissions.
Aspect 14: A method for wireless communications at a base station, comprising: transmitting, to a UE, a downlink control information message comprising a first indication of one or more transmission configuration indicator states for the UE to use for communications with the base station and a second indication corresponding to one or more uplink transmissions for the UE to transmit to the base station; receiving, from the UE, at least one of the one or more uplink transmissions based at least in part on transmitting the downlink control information comprising the second indication; and communicating with the UE using the one or more transmission configuration indicator states and after a delay, the delay initiated based at least in part on receiving the at least one of the one or more uplink transmissions.
Aspect 15: The method of aspect 14, wherein transmitting the downlink control information message comprises: transmitting the downlink control information message comprising the second indication scheduling one or more uplink shared channel transmissions, wherein the at least one of the one or more uplink transmissions comprises at least one of the one or more uplink shared channel transmissions and the delay is initiated based at least in part on receiving the at least one of the one or more uplink shared channel transmissions.
Aspect 16: The method of aspect 14, wherein transmitting the downlink control information message comprises: transmitting the downlink control information message comprising the second indication scheduling one or more sounding reference signal transmissions, wherein the at least one of the one or more uplink transmissions comprises at least one of the one or more sounding reference signal transmissions and the delay is initiated based at least in part on receiving the at least one of the one or more sounding reference signal transmissions.
Aspect 17: The method of aspect 16, wherein the at least one of the one or more sounding reference signals comprises a lowest resource set identifier of a plurality of resource set identifiers or a highest resource set identifier of the plurality of resource set identifiers, each of the plurality of resource set identifiers corresponding to a respective sounding reference signal of the one or more sounding reference signals.
Aspect 18: The method of aspect 14, wherein transmitting the downlink control information message comprises: transmitting the downlink control information message comprising the second indication scheduling one or more channel state information reports, wherein the at least one of the one or more uplink transmissions comprises at least one of the one or more channel state information reports and the delay is initiated based at least in part on receiving the at least one of the one or more channel state information reports.
Aspect 19: The method of aspect 14, wherein transmitting the downlink control information message comprises: transmitting the downlink control information message comprising the second indication scheduling one or more semi-persistent scheduling downlink channel reception opportunities, wherein the at least one of the one or more uplink transmissions comprises an acknowledgment feedback message for at least one of the one or more semi-persistent scheduling downlink channel reception opportunities and the delay is initiated based at least in part on receiving the acknowledgment feedback message.
Aspect 20: The method of aspect 14, wherein transmitting the downlink control information message comprises: transmitting the downlink control information message comprising the second indication that includes an activation indication for one or more configured grant uplink transmissions, wherein the at least one of the one or more uplink transmissions comprises a confirmation message for the activation indication or the at least one of the one or more uplink transmissions comprises at least one of the one or more configured grant uplink transmissions and the delay is initiated based at least in part on receiving the confirmation message or the at least one of the one or more configured grant uplink transmissions.
Aspect 21: The method of aspect 20, wherein the confirmation message comprises a configured grant confirmation medium access control control element transmission confirming the reception of the downlink control information message activating the one or more configured grant uplink transmissions at the UE.
Aspect 22: The method of any of aspects 14 through 21, wherein transmitting the downlink control information message comprises: transmitting the downlink control information message comprising the second indication scheduling the one or more uplink transmissions in respective transmission opportunities, wherein the delay is initiated based at least in part on a transmission opportunity of the respective transmission opportunities.
Aspect 23: The method of any of aspects 14 through 22, wherein the delay comprises an amount of time or a quantity of symbols between receiving the at least one of the one or more uplink transmissions and communicating with the UE using the one or more transmission configuration indicator states.
Aspect 24: The method of any of aspects 14 through 23, wherein the delay is initiated after a starting symbol of the at least one of the one or more uplink transmissions or after an ending symbol of the at least one of the one or more uplink transmissions.
Aspect 25: An apparatus for wireless communications at a UE, comprising a processor; memory coupled with the processor; and instructions stored in the memory and executable by the processor to cause the apparatus to perform a method of any of aspects 1 through 13.
Aspect 26: An apparatus for wireless communications at a UE, comprising at least one means for performing a method of any of aspects 1 through 13.
Aspect 27: A non-transitory computer-readable medium storing code for wireless communications at a UE, the code comprising instructions executable by a processor to perform a method of any of aspects 1 through 13.
Aspect 28: An apparatus for wireless communications at a base station, comprising a processor; memory coupled with the processor; and instructions stored in the memory and executable by the processor to cause the apparatus to perform a method of any of aspects 14 through 24.
Aspect 29: An apparatus for wireless communications at a base station, comprising at least one means for performing a method of any of aspects 14 through 24.
Aspect 30: A non-transitory computer-readable medium storing code for wireless communications at a base station, the code comprising instructions executable by a processor to perform a method of any of aspects 14 through 24.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (for example, a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc in which disks usually reproduce data magnetically, while discs reproduce data optically with lasers. Combinations of the above are also included within the scope of computer-readable media.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (that is, A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a downlink control information message comprising a first indication of one or more transmission configuration indicator states for communications with the base station and a second indication corresponding to one or more uplink transmissions for transmitting to the base station;
transmitting, to the base station, at least one of the one or more uplink transmissions based at least in part on receiving the downlink control information message comprising the second indication; and
communicating with the base station using the one or more transmission configuration indicator states and after a delay, the delay initiated based at least in part on transmitting the at least one of the one or more uplink transmissions.

2. The method of claim 1, wherein receiving the downlink control information message comprises receiving the downlink control information message comprising the second indication scheduling one or more uplink shared channel transmissions, wherein the at least one of the one or more uplink transmissions comprises at least one of the one or more uplink shared channel transmissions and the delay is initiated based at least in part on transmitting the at least one of the one or more uplink shared channel transmissions.

3. The method of claim 1, wherein receiving the downlink control information message comprises receiving the downlink control information message comprising the second indication scheduling one or more sounding reference signal transmissions, wherein the at least one of the one or more uplink transmissions comprises at least one of the one or more sounding reference signal transmissions and the delay is initiated based at least in part on transmitting the at least one of the one or more sounding reference signal transmissions.

4. The method of claim 3, wherein the at least one of the one or more sounding reference signal transmissions comprises a lowest resource set identifier of a plurality of resource set identifiers or a highest resource set identifier of the plurality of resource set identifiers, each of the plurality of resource set identifiers corresponding to a respective sounding reference signal transmission of the one or more sounding reference signal transmissions.

5. The method of claim 1, wherein receiving the downlink control information message comprises receiving the downlink control information message comprising the second indication scheduling one or more channel state information reports, wherein the at least one of the one or more uplink transmissions comprises at least one of the one or more channel state information reports and the delay is initiated based at least in part on transmitting the at least one of the one or more channel state information reports.

6. The method of any of claims 1-5, further comprising:
receiving an additional downlink control information message comprising the first indication of the one or more transmission configuration indicator states for communications with the base station and an additional indication to perform a channel state information measurement operation; and
refraining from communicating with the base station using the one or more transmission configuration indicator states based at least in part on the additional indication in the additional downlink control information message comprising the additional indication to perform the channel state information measurement operation.

7. The method of claim 1, wherein receiving the downlink control information message comprises receiving the downlink control information message comprising the second indication scheduling one or more semi-persistent scheduling downlink channel reception opportunities, wherein the at least one of the one or more uplink transmissions comprises an acknowledgment feedback message for at least one of the one or more semi-persistent scheduling downlink channel reception opportunities and the delay is initiated based at least in part on transmitting the acknowledgment feedback message.

8. The method of claim 1, wherein receiving the downlink control information message comprises receiving the downlink control information message comprising the second indication that includes an activation indication for one or more configured grant uplink transmissions, wherein the at least one of the one or more uplink transmissions comprises a confirmation message for the activation indication or the at least one of the one or more uplink transmissions comprises at least one of the one or more configured grant uplink transmissions and the delay is initiated based at least in part on transmitting the confirmation message or the at least one of the one or more configured grant uplink transmissions.

9. The method of claim 8, wherein the confirmation message comprises a configured grant confirmation medium access control control element transmission confirming reception of the downlink control information message activating the one or more configured grant uplink transmissions.

10. The method of any of claims 1-9, further comprising:
receiving an additional downlink control information message comprising the first indication of the one or more transmission configuration indicator states for communications with the base station and an additional indication of a dormancy for a secondary cell of the UE; and
refraining from communicating with the base station using the one or more transmission configuration indicator states based at least in part on the additional indication in the additional downlink control information message comprising the additional indication of the dormancy for the secondary cell of the UE and no downlink shared channel receptions occurring on the secondary cell.

11. The method of any of claims 1-10, wherein receiving the downlink control information message comprises receiving the downlink control information message comprising the second indication scheduling the one or more uplink transmissions in respective transmission opportunities, wherein the delay is initiated based at least in part on a transmission opportunity of the respective transmission opportunities.

12. The method of any of claims 1-11, wherein the delay comprises an amount of time or a quantity of symbols between transmitting the at least one of the one or more uplink transmissions and communicating with the base station using the one or more transmission configuration indicator states.

13. The method of any of claims 1-12, wherein the delay is initiated after a starting symbol of the at least one of the one or more uplink transmissions or after an ending symbol of the at least one of the one or more uplink transmissions.

14. A method for wireless communications at a base station, comprising:
transmitting, to a user equipment (UE), a downlink control information message comprising a first indication of one or more transmission configuration indicator states for the UE to use for communications with the base station and a second indication corresponding to one or more uplink transmissions for the UE to transmit to the base station;
receiving, from the UE, at least one of the one or more uplink transmissions based at least in part on transmitting the downlink control information message comprising the second indication; and
communicating with the UE using the one or more transmission configuration indicator states and after a delay, the delay initiated based at least in part on receiving the at least one of the one or more uplink transmissions.

15. The method of claim 14, wherein transmitting the downlink control information message comprises transmitting the downlink control information message comprising the second indication scheduling one or more uplink shared channel transmissions, wherein the at least one of the one or more uplink transmissions comprises at least one of the one or more uplink shared channel transmissions and the delay is initiated based at least in part on receiving the at least one of the one or more uplink shared channel transmissions.

16. The method of claim 14, wherein transmitting the downlink control information message comprises transmitting the downlink control information message comprising the second indication scheduling one or more sounding reference signal transmissions, wherein the at least one of the one or more uplink transmissions comprises at least one of the one or more sounding reference signal transmissions and the delay is initiated based at least in part on receiving the at least one of the one or more sounding reference signal transmissions.

17. The method of claim 16, wherein the at least one of the one or more sounding reference signal transmissions comprises a lowest resource set identifier of a plurality of resource set identifiers or a highest resource set identifier of the plurality of resource set identifiers, each of the plurality of resource set identifiers corresponding to a respective sounding reference signal of the one or more sounding reference signal transmissions.

18. The method of claim 14, wherein transmitting the downlink control information message comprises transmitting the downlink control information message comprising the second indication scheduling one or more channel state information reports, wherein the at least one of the one or more uplink transmissions comprises at least one of the one or more channel state information reports and the delay is initiated based at least in part on receiving the at least one of the one or more channel state information reports.

19. The method of claim 14, wherein transmitting the downlink control information message comprises transmitting the downlink control information message comprising the second indication scheduling one or more semi-persistent scheduling downlink channel reception opportunities, wherein the at least one of the one or more uplink transmissions comprises an acknowledgment feedback message for at least one of the one or more semi-persistent scheduling downlink channel reception opportunities and the delay is initiated based at least in part on receiving the acknowledgment feedback message.

20. The method of claim 14, wherein transmitting the downlink control information message comprises transmitting the downlink control information message comprising the second indication that includes an activation indication for one or more configured grant uplink transmissions, wherein the at least one of the one or more uplink transmissions comprises a confirmation message for the activation indication or the at least one of the one or more uplink transmissions comprises at least one of the one or more configured grant uplink transmissions and the delay is initiated based at least in part on receiving the confirmation message or the at least one of the one or more configured grant uplink transmissions.

21. The method of claim 20, wherein the confirmation message comprises a configured grant confirmation medium access control control element transmission confirming reception of the downlink control information message activating the one or more configured grant uplink transmissions at the UE.

22. The method of any of claims 14-21, wherein transmitting the downlink control information message comprises transmitting the downlink control information message comprising the second indication scheduling the one or more uplink transmissions in respective transmission opportunities, wherein the delay is initiated based at least in part on a transmission opportunity of the respective transmission opportunities.

23. The method of any of claims 14-22, wherein the delay comprises an amount of time or a quantity of symbols between receiving the at least one of the one or more uplink transmissions and communicating with the UE using the one or more transmission configuration indicator states.

24. The method of any of claims 14-23, wherein the delay is initiated after a starting symbol of the at least one of the one or more uplink transmissions or after an ending symbol of the at least one of the one or more uplink transmissions.

25. An apparatus for wireless communications at a user equipment (UE), comprising:
a processor;
memory coupled with the processor; and
instructions stored in the memory and executable by the processor to cause the apparatus to:
receive, from a base station, a downlink control information message comprising a first indication of one or more transmission configuration indicator states for communications with the base station and a second indication corresponding to one or more uplink transmissions for transmitting to the base station;
transmit, to the base station, at least one of the one or more uplink transmissions based at least in part on receiving the downlink control information message comprising the second indication; and
communicate with the base station using the one or more transmission configuration indicator states and after a delay, the delay initiated based at least in part on transmitting the at least one of the one or more uplink transmissions.

26. The apparatus of claim 25, wherein the instructions to receive the downlink control information message are executable by the processor to cause the apparatus to receive the downlink control information message comprising the second indication scheduling one or more uplink shared channel transmissions, wherein the at least one of the one or more uplink transmissions comprises at least one of the one or more uplink shared channel transmissions and the delay is initiated based at least in part on transmitting the at least one of the one or more uplink shared channel transmissions.

27. The apparatus of claim 25, wherein the instructions to receive the downlink control information message are executable by the processor to cause the apparatus to receive the downlink control information message comprising the second indication scheduling one or more sounding reference signal transmissions, wherein the at least one of the one or more uplink transmissions comprises at least one of the one or more sounding reference signal transmissions and the delay is initiated based at least in part on transmitting the at least one of the one or more sounding reference signal transmissions.

28. The apparatus of claim 25, wherein the instructions to receive the downlink control information message are executable by the processor to cause the apparatus to receive the downlink control information message comprising the second indication scheduling one or more channel state information reports, wherein the at least one of the one or more uplink transmissions comprises at least one of the one or more channel state information reports and the delay is initiated based at least in part on transmitting the at least one of the one or more channel state information reports.

29. The apparatus of claim 25, wherein the instructions to receive the downlink control information message are executable by the processor to cause the apparatus to receive the downlink control information message comprising the second indication scheduling one or more semi-persistent scheduling downlink channel reception opportunities, wherein the at least one of the one or more uplink transmissions comprises an acknowledgment feedback message for at least one of the one or more semi-persistent scheduling downlink channel reception opportunities and the delay is initiated based at least in part on transmitting the acknowledgment feedback message.

30. An apparatus for wireless communications at a base station, comprising:
a processor;
memory coupled with the processor; and
instructions stored in the memory and executable by the processor to cause the apparatus to:
transmit, to a user equipment (UE), a downlink control information message comprising a first indication of one or more transmission configuration indicator states for the UE to use for communications with the base station and a second indication corresponding to one or more uplink transmissions for the UE to transmit to the base station;
receive, from the UE, at least one of the one or more uplink transmissions based at least in part on transmitting the downlink control information message comprising the second indication; and
communicate with the UE using the one or more transmission configuration indicator states and after a delay, the delay initiated based at least in part on receiving the at least one of the one or more uplink transmissions.
